(19) United States
(12) Patent Application Publication
(10) Pub. No.: US 2024/0244636 A1
(43) Pub. Date: Jul. 18, 2024

(54) METHOD AND APPARATUS TO ADDRESS TIMING RELATED ISSUES IN BEAM MANAGEMENT FOR B52 GHz COMMUNICATIONS

(71) Applicant: Huawei Technologies Co., Ltd., Shenzhen (CN)

(72) Inventors: Narayan Prasad, Westfield, NJ (US); George Calcev, Hoffman Estates, IL (US); Weimin Xiao, Hoffman Estates, IL (US); Qian Gao, Plano, TX (US)

(21) Appl. No.: 18/618,492

(22) Filed: Mar. 27, 2024

Related U.S. Application Data
(63) Continuation of application No. PCT/US2022/044581, filed on Sep. 23, 2022.
(60) Provisional application No. 63/275,814, filed on Nov. 4, 2021.
(60) Provisional application No. 63/250,764, filed on Sep. 30, 2021.

(51) Int. Cl. H04W 72/232; H04L 5/00

(52) U.S. Cl. CPC H04W 72/232; H04L 5/0053

(57) ABSTRACT

Embodiments of the present disclosure provide methods and apparatuses in the field of beam management. Some embodiments receive a downlink control information (DCI), the DCI scheduling one or more data channel transmissions. Some embodiments determines, a receive beam based on a time duration for quasi co-location (QCL), a scheduling offset, and a minimum time offset. Some embodiments receive using the receive beam, data symbols from the one or more data channel transmissions scheduled by the DCI.

### PRIORITY CLAIM AND CROSS-REFERENCE

This application is a continuation of PCT/US2022/044581, filed on Sep. 23, 2022, and entitled “Method and Apparatus to Address Timing Related Issues in Beam Management for B52 GHz Communications,” which claims priority to U.S. Provisional Application No. 63/275,814, filed on Nov. 4, 2021 and entitled “Method and Apparatus to Address Timing Related Issues in Beam Management for B52 GHz Communications,” and U.S. Provisional Application No. 63/250,764, filed on Sep. 30, 2021 and entitled “Method and Apparatus to Address Timing Related Issues in Beam Management for B52 GHz Communications,” applications of which are incorporated by reference herein as if reproduced in their entirety.

### TECHNICAL FIELD

The present disclosure relates generally to managing the allocation of resources in a network, and in particular embodiments, to techniques and mechanisms for defining precedence and switching rules for beam switching and default beam selection in single downlink control information (DCI) multi physical downlink shared channel (PDSCH) scheduling.

### BACKGROUND

The beyond 52.6 GHz frequency range (e.g. 52.6 GHz-to-71 GHz) is a band for new radio (NR) operations. The process of detailing NR features for this range is referred to as FR 2-2 or B52. Analog beamforming is essential in this range for overcoming high propagation loss at these frequencies in this range. The present disclosure addresses techniques and mechanisms for beam-management issues resulting from user equipment (UE) processing timelines.

### SUMMARY OF THE DISCLOSURE

Technical advantages are generally achieved, by embodiments of this disclosure which describe techniques and mechanisms for beam-management.

In accordance with an embodiment, a method is provided. The method comprises, receiving, by a user equipment (UE), a downlink control information (DCI), the DCI scheduling one or more data channel transmissions; determining, by the UE, a receive beam based on a time duration for quasi co-location (QCL), a scheduling offset, and a minimum time offset; and receiving, by the UE using the receive beam, data symbols from the one or more data channel transmissions scheduled by the DCI.

Optionally, in any of the preceding aspects, the scheduling offset is a time offset between a last symbol of a physical downlink control channel (PDCCH) monitoring occasion that contains the DCI and a first symbol of the data symbols from the one or more data channel transmissions.

Optionally, in any of the preceding aspects, the scheduling offset is less than the time duration for QCL, and wherein the receive beam is a default beam.

Optionally, in any of the preceding aspects, a first data symbol of the data symbols is at least the minimum time offset after a PDCCH monitoring occasion that contains the DCI.

Optionally, in any of the preceding aspects, the default beam corresponds to a search space set of a plurality of search space sets, and each search space set of the plurality of search space sets is associated with a corresponding default beam and a corresponding minimum time offset.

Optionally, in any of the preceding aspects, one or more control resource sets (CORESETs) are assigned to the UE, wherein each of the one or more CORESETs is configured with a corresponding valid default beam flag, wherein the one or more CORESETs include at least one CORESET with the corresponding valid default beam flag set to be true, and wherein the default beam is based on QCL parameters of a CORESET with a lowest CORESET identifier (ID) among the at least one CORESET.

Optionally, in any of the preceding aspects, each corresponding valid default beam flag is UE-specific and configured via radio resource control (RRC) signaling.

Optionally, in any of the preceding aspects, the at least one CORESET with the corresponding valid default beam flag set to be true is prior to a slot containing the data symbols.

Optionally, in any of the preceding aspects, the scheduling offset is greater than or equal to the time duration for QCL, and the receive beam is determined based on a transmit configuration indicator (TCI) field indicated by the DCI, or the receive beam is a prior receive beam used by a monitoring occasion containing the DCI when the TCI field is absent in the DCI.

Optionally, in any of the preceding aspects, a time gap between any PDCCH consecutive monitoring occasions with UE-specific search space sets (USSs) is greater than or equal to the time duration for QCL.

Optionally, in any of the preceding aspects, the minimum time offset is configured by a base station using radio resource control (RRC) signaling.

Optionally, in any of the preceding aspects, the method further comprises, receiving, by the UE, a second DCI, wherein data transmission scheduled by the second DCI is after the data symbols from the one or more data channels scheduled by the DCI.

Optionally, in any of the preceding aspects, the method further comprises, receiving, by the UE, a second DCI, wherein at least one of the DCI and the second DCI schedules multi-slot transmission, and wherein the second DCI is ignored by the UE.

Optionally, in any of the preceding aspects, the receive beam is different from a current receive beam, and the method further comprises determining, by the UE, a decision of a beam switch from the current receive beam to the receive beam based on a precedence relation.

In accordance with another embodiment, another method is provided. The method comprises, receiving, by a user equipment (UE), a first symbol using a first receive beam; determining, by the UE, a decision of a beam switch from the first receive beam to a second receive beam based on a precedence relation between the first symbol and a second symbol adjacent to the first symbol; and receiving, by the UE, the second symbol based on the decision of the beam switch.

Optionally, in any of the preceding aspects, a beam switch capability is not signaled by the UE or the UE is incapable of adjacent symbol reception and beam switch, and wherein the first receive beam and the second receive beam are the same.

Optionally, in any of the preceding aspects, the UE is incapable of adjacent symbol reception and beam switch, and the precedence relation is based on priorities of a first type of the first symbol and a second type of the second symbol in an decreasing order of (o) synchronization signal block (SSB) or channel state information reference signal (CSI-RS) for layer 1 reference signal received power (L1-RSRP), (1) control resource set (CORESET) containing common search space (CSS), (2) CORESET containing UE-specific search space (USS), (3) CSI-RS for tracking, beam training, or channel quality information (CQI), (4) physical downlink shared channel (PDSCH) demodulation reference signal (DMRS), (5) PDSCH data, (6) indeterminate symbol, and (7) gap symbol, and in CORESETs of a same order, a first CORESET with a lower CORESET identifier (ID) has a higher priority than a second CORESET with a higher CORESET ID.

Optionally, in any of the preceding aspects, the UE is incapable of adjacent symbol reception that requires a beam switch, and the precedence relation is based on priorities of a first type of the first symbol and a second type of the second symbol in an decreasing order of (0) SSB, CSI-RS for L1-RSRP, (1) CORESET whose ID is 0, (2) CORESET whose ID is greater than 1, (3) CSI-RS for tracking, beam training, or CQI, (4) PDSCH DMRS, (5) PDSCH data, (6) indeterminate symbol, and (7) gap symbol, and in CORESETs of a same order, a first CORESET with a lower CORESET ID has a higher priority than a second CORESET with a higher CORESET ID.

Optionally, in any of the preceding aspects, the decision of the beam switch includes which symbol to switch on based on the precedence relation.

Optionally, in any of the preceding aspects, the precedence relation includes a first CORESET ID of a first CORESET containing the first symbol being less than a second CORESET ID of a second CORESET containing the second symbol, and based on a quantity of symbols in the second CORESET being less than 2, the decision of the beam switch includes receiving the second symbol using the first receive beam without performing the beam switch, or based on the quantity of symbols in the second CORESET being more than 1, the decision of the beam switch includes performing the beam switch on a first control symbol of the second CORESET and receiving remaining symbols of the second CORESET and data symbols of a data channel adjacent to and after the second CORESET using the second receive beam.

Optionally, in any of the preceding aspects, the precedence relation includes a first CORESET ID of a first CORESET containing the first symbol being greater than a second CORESET ID of a second CORESET containing the second symbol, the decision of the beam switch includes performing the beam switch on a last control symbol of the first CORESET and receiving symbols of the second CORESET and data symbols of a data channel adjacent to and after the second CORESET using the second receive beam.

In accordance with yet another embodiment, a user equipment (UE) for performing any of the preceding methods or aspects of the methods is provided. The UE comprises, one or more processors; and a non-transitory memory storage comprising instructions that, when executed by the one or more processors, cause the UE to perform a method of any of the preceding methods or aspects of the methods.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of an embodiment wireless communications network;

FIG. 2 illustrates a diagram of a scheduling scenario;

FIG. 3 illustrates a diagram of a configuration with varying beam switch requirements across slots;

FIG. 4 illustrates a diagram of Multi-slot PDSCH scheduling;

FIG. 5A illustrates a diagram of a UE following expected behavior;

FIG. 5B illustrates a diagram of desired or intended UE behavior;

FIG. 5C illustrates a diagram of actual UE behavior due to ambiguity;

FIG. 6 illustrates a diagram of another PDCCH MO occurring within timeDurationForQCL from a previous PDCCH MO;

FIG. 7A illustrates a diagram of default beam based UE operation for first setting of K0_min1 and K0_min2 in accordance with example embodiments disclosed herein;

FIG. 7B illustrates a diagram of default beam based UE operation for second setting of K0_min1 and K0_min2 in accordance with example embodiments disclosed herein;

FIG. 7C illustrates a diagram of default beam based UE operation for third setting of K0_min1 and K0_min2 in accordance with example embodiments disclosed herein;

FIG. 8 illustrates a diagram of a flowchart of UE side default beam based operation in accordance with example embodiments disclosed herein;

FIG. 9 illustrates a diagram of a flowchart of default beam selection in accordance with example embodiments disclosed herein;

FIG. 10A illustrates a diagram of a scheduling allocation without any beam determined for the scheduled PDSCH in accordance with example embodiments disclosed herein;

FIG. 10B illustrates a diagram of a scheduling allocation in which beams to receive PDSCH have been determined in accordance with example embodiments disclosed herein;

FIG. 11 illustrates a diagram of overlap between timeDurationForQCL spans corresponding to consecutive PDCCH MO in accordance with example embodiments disclosed herein;

FIG. 12 illustrates a diagram of consecutive PDCCH symbols;

FIG. 13 illustrates a diagram of an example scenario with multiple MO in proximity;

FIG. 14 illustrates a diagram of a flowchart to enforce per-slot maximum beam switch limit in accordance with example embodiments disclosed herein;

FIG. 15A-FIG. 15C illustrate diagrams of an example switch limit;

FIG. 16 illustrates a diagram of a flowchart of a UE processing giving precedence of CORESET having a lower ID in accordance with example embodiments disclosed herein;

FIG. 17 illustrates a diagram of a flowchart of a UE processing switching on the first PDSCH symbol to receive remaining symbols using its assigned beam in accordance with example embodiments disclosed herein;

FIG. 18 illustrates an example diagram of the impact of beam switching gap on multi-slot PDSCH scheduling in accordance with example embodiments disclosed herein;

FIG. 19 illustrates an example communication system according to example embodiments presented herein;

FIGS. 20A and 20B illustrate example devices that may implement the methods and teachings according to this disclosure; and

FIG. 21 is a block diagram of a computing system that may be used for implementing the devices and methods disclosed herein.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

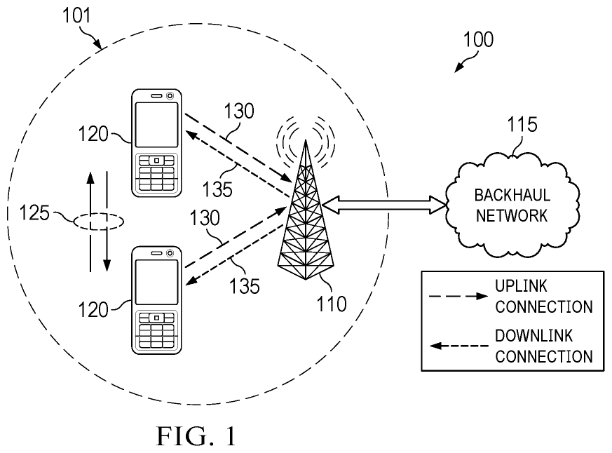

FIG. 1 illustrates an example communications system 100. Communications system 100 includes an access node 110 serving user equipments (UEs) with coverage 101, such as UEs 120. In a first operating mode, communications to and from a UE passes through access node 110 with a coverage area 101. The access node 110 is connected to a backhaul network 115 for connecting to the internet, operations and management, and so forth. In a second operating mode, communications to and from a UE do not pass through access node 110, however, access node 110 typically allocates resources used by the UE to communicate when specific conditions are met. Communications between a pair of UEs 120 can use a sidelink connection (shown as two separate one-way connections 125). In FIG. 1, the sideline communication is occurring between two UEs operating inside of coverage area 101. However, sidelink communications, in general, can occur when UEs 120 are both outside coverage area 101, both inside coverage area 101, or one inside and the other outside coverage area 101. Communication between a UE and access node pair occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), fifth generation (5G), 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

Disclosed herein two key inter-related beam-management issues resulting from UE processing timelines are considered.

The first issue is the setting of a single DCI scheduling multiple PDSCHs for a UE. In order to receive each PDSCH of the UE's scheduled PDSCHs, the UE must employ a suitable receive spatial filter or receive analog beamforming vector (e.g., a receive beam). The appropriate choice of a beam is conveyed to the UE in the UE's scheduling DCI implicitly or explicitly via a transmit configuration indicator (TCI) field that can have one or more TCI states. A TCI state in a TCI field in the DCI conveys quasi co-location (QCL)-TypeD (spatial QCL) source information. The spatial QCL source information informs the UE that the receive beam that the UE should use is the same beam the UE used to receive a QCL source, which comprises typically channel state information reference signal (CSI-RS) signals. Absence of the TCI field from the DCI also implicitly informs the UE about particular QCL source information. However, a UE requires a certain time to perform physical downlink control channel (PDCCH) reception, detect a DCI intended for the UE, decode that DCI to retrieve scheduling information, and apply implicitly or explicitly indicated spatial QCL information to prepare spatial receive filters for receiving the scheduled PDSCH. This time duration is referred to as timeDurationForQCL, and timeDurationForQCL is signaled as a UE capability (e.g., in number of orthogonal frequency division multiplexing (OFDM) symbols, one for each sub-carrier spacing). Candidate values can be 56 symbols (4 slots) and 112 symbols (8 slots) for 480 kHz sub-carrier-spacing (SCS) as well as 112 symbols (8 slots) and 224 symbols (16 slots) for 960 kHz sub-carrier-spacing (SCS).

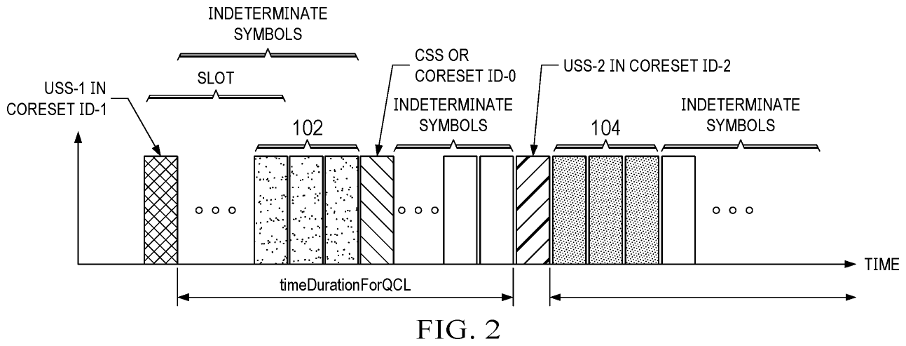

Consider symbols that are within timeDurationForQCL symbols from a PDCCH monitoring occasion that might contain a DCI intended for the UE, since timeDurationForQCL does not indicate a reception gap at the UE, these symbols must be received and buffered by the UE. However, while receiving these symbols, the UE is uncertain whether these symbols actually contain data or pilots intended for it. Such symbols are referred to as indeterminate symbols and depicted in FIG. 2.

In particular, in FIG. 2, a DCI present in a user-specific search (USS) space set (USS-1) schedules multiple PDSCH slots (with data symbols 102 and 104). However, the UE needs at-least timeDurationForQCL symbols (after receiving symbol(s) of the USS-1) for detecting the DCI intended for the UE, processing the DCI's contents, and preparing any analog spatial receive (RX) beam the UE is supposed to apply in order to receive the UE's assigned PDSCH symbols, if that DCI indicates a beam change. Since only one capability value for timeDurationForQCL is signaled per sub-carrier spacing, the gNB has to assume this signaled capability value to be the one required by the UE to process the UE's DCI even when there is no indicated beam change. Moreover, the indeterminate symbols received within this time duration (timeDurationForQCL) must be received using some default analog RX beam and buffered. In FIG. 2 the symbols 104 are known to the UE as the UE's PDSCH symbols since the DCI intended for it that was present in USS-1 was decoded prior to receiving those symbols. The symbols 102 are known to the UE to be the UE's PDSCH symbols only after those symbols have been received and buffered. Similarly, the unshaded symbols following the USS-2 or CSS are also indeterminate because the UE does not know if any of these unshaded symbols is a PDSCH symbol scheduled by a DCI present in the CSS or USS-2. Thus, there is a dilemma about which beam(s) should be used as default beam(s) to receive the indeterminate symbols.

The control resource set (CORESET) associated with the CSS can have a configured TCI state that is distinct from the one(s) configured for the USS-1 and USS-2. Typically, CSS CORESETs are configured with a wider beam that sacrifices beamforming-gain for coverage (larger beamwidth). With regard to selecting a default beam, on one hand, using a single default beam to receive all scheduled PDSCHs by a single DCI has certain advantages (such as improved channel estimation, automatic gain control (AGC) tuning, modulation coding scheme (MCS) determination) whenever the choice of this single default beam is appropriate and is unambiguous to the UE. On the other hand, the latter conditions cannot always be satisfied. This disclosure presents several embodiments pertaining to the choice of default beam(s).

The second issue deals with the impact of two UE signaled capabilities: beam switching gap and maxNumberRxTxBeamSwitchDL.

Beam switch gap is defined as the minimum time duration for a UE to perform spatial beam direction change. In the lower sub-carrier spacing (SCS) of frequency range 2 (FR2) (also referred to as FR2-1), even assuming a conservative beam switch time of 100 ns, it was possible to accommodate this switch time within the cyclic prefix (SP) which is at-least 584 ns.

However, in B52 (or FR2-2), the cyclic prefix (CP) length is 73 ns for the SCS of 960 kHz and 146 ns for the SCS of 480 kHz. While the exact beam switch time is still under discussion, it has been reported that even the gNB will need a beam switch time gap of at-least 59 ns, which means that a UE will quite likely need a beam switch time gap of more than 73 ns. Further, upon adding delay spread, timing errors, and other impairments it may even be infeasible to accommodate beam switch duration within the 146 ns CP length for SCS of 480 kHz.

As noted above, since beam switch gap is not an issue in FR 2-1, and there are several situations in FR2-1 where such beam switching and reception over consecutive OFDM symbols is required to be performed by the UE. Some examples of specific instances are: (i) when CSI-RS associated with different beams (distinct QCL-TypeD assumptions) are assigned to the same user over adjacent OFDM symbols, (ii) when a PDCCH monitoring occasion assigned to a UE is immediately followed by a PDSCH symbol scheduled for that UE, with their associated receive beam directions being different, or even (iii) two different PDCCH monitoring occasions in a slot are assigned to the same UE while being adjacent to each other and further associated with distinct QCL-TypeD (QCL-D) assumptions.

The parameter maxNumberRxTxBeamSwitchDL is the maximum number of beam switches that a UE can make in a slot duration. A UE in FR 2-2 is expected to repurpose the legacy hardware and design from FR 2-1 to a significant extent but has to contend with much shorter symbol durations in FR 2-2 (4 and 8 times shorter for 480 SCS and 960 kHz SCS, respectively, compared to 120 kHz SCS in FR 2-1). As a result, there are new smaller values (2 and possibly 1) that have been introduced as additional UE maxNumberRxTxBeamSwitchDL capability values.

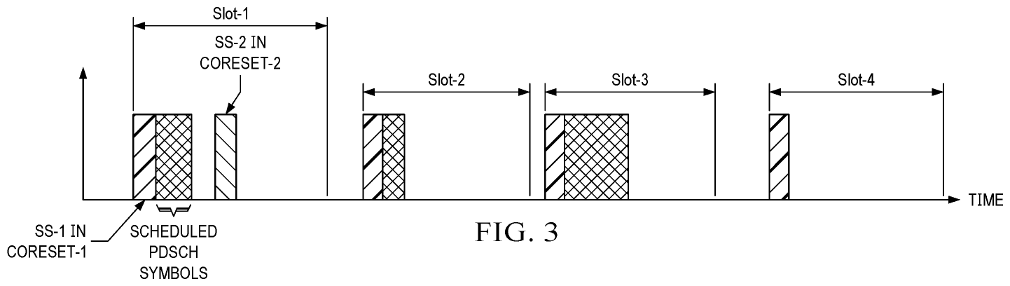

Multiple situations entailing adjacent symbol reception and beam switch, or a larger number of switches in a slot can present themselves in FR2-2. Even though scheduling by the gNB can ensure many of such situations are avoided, relying on gNB scheduling alone can be quite a conservative approach that is limited by the worst-case scenario. For instance, consider the configuration of search space sets for a UE (each search space (SS) set being assigned a CORESET) which is done in a semi-static manner with some configured parameters for a search space set being offset, periodicity, and duration. For several configuration choices, the number of monitoring occasions can vary across different slots, and symbols of these monitoring occasions can require UE to receive them with distinct beams. Indeed, for many such configurations only a few slots might entail a larger beam switching burden on the UE while remaining ones may not. An example is presented in FIG. 3, where the monitored CORESETs and the scheduled PDSCH symbols (and the indeterminate symbols which are not explicitly shown) may need to be received using different beams. As seen, the beam switching burden is smaller in slots 2, 3, and 4 since search-space-2 (SS-2) is absent in those slots. If the beam switch requirement for slot 1 exceeds UE maxNumberRxTxBeamSwitchDL limit, then relying on scheduling alone may invalidate this configuration even though most slots entail switches that are within UE limit.

Therefore, a more prudent approach is to ensure that UE behavior—when presented with a situation entailing adjacent symbol reception and beam switch exceeding its capability and/or entailing more beam switches in a slot than its maxNumberRxTxBeamSwitchDL capability—is unambiguously defined, while respecting both these UE capabilities. This disclosure presents several embodiments defining UE behavior for such cases.

Finally, the third issue is the interplay between the first and second issues and present embodiments that incorporate beam switching gap and maxNumberRxTxBeamSwitchDL considerations in the default beam selection rules. This disclosure will use the phrase “adjacent symbol beam switch exceeding UE capability” or “beam switch over adjacent (consecutive) symbols exceeds UE capability” to imply that the UE is incapable of receiving two consecutive (adjacent) OFDM symbols using different RX beams.

In other words, the second issue arises after the UE knows a scheduled allocation, i.e., the UE knows where and when the UE is expected (as per the allocation) to switch a beam. For situations when this cannot be met under UE's beam switch capabilities, the UE behavior needs to be specified. Without such specification, the UE behavior will be unknown to the gNB and consequently the latter will avoid all such allocations. Thereby, the gNB ends up relying on scheduling alone and being limited by the worst-case, and the gNB has to forgo many configurations. The latter will reduce capacity of the system (for instance number of active users that can be handled).

The first issue arises, when a scheduled allocation is unknown to the UE (i.e., the UE has not yet decoded the scheduling DCI), so the UE does not know when the scheduled PDSCH transmission takes place and which beam needs to be used by the UE for receiving the PDSCH transmission. The UE needs at least timeDurationForQCL duration to be aware of the exact spatial filtering (exact beam) for reception and to prepare and change to that beam. The first issue pertains to defining how UE must behave during the span of timeDurationForQCL from a PDCCH monitoring occasion. Without such specification of the UE behavior, the gNB will have to wait timeDurationForQCL duration after a scheduling DCI, before transmitting scheduled PDSCH. This will adversely impact ability to serve latency-constrained traffic.

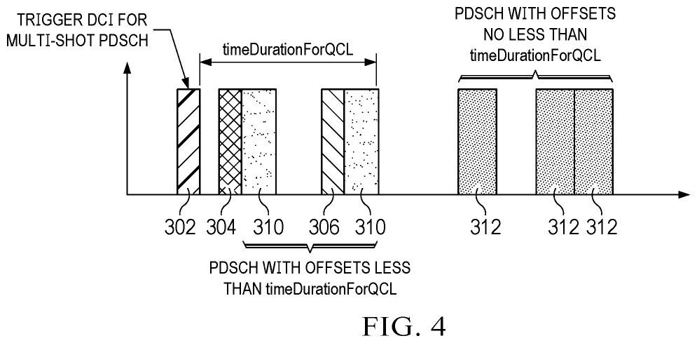

There can be several issues in the process of default beam selection by a UE. FIG. 4 depicts monitoring occasions 302, 304, and 306 and multi-slot PDSCH scheduling with a single DCI. Firstly, the UE can apply the TCI state indicated in the triggering DCI 302 for all PDSCHs (e.g., symbols) 312 with scheduling offsets no less than timeDurationForQCL. However, rules for default beam selection need to be defined at-least for all PDSCHs (e.g., symbols) 310 with scheduling offsets less than timeDurationForQCL. Such a default beam selection rule can be particularly beneficial for delay-constrained traffic (for instance URLLC traffic) since such a rule would allow the gNB to transmit delay constrained traffic without waiting to ensure that the PDSCH carrying such traffic have offsets at-least as much as the timeDurationForQCL.

The possible options for this issue can be summarized as in the following framework:
For multi-PDSCHs scheduled by a single DCI with a single TCI state,
Case 1: PDSCH scheduling offset for all PDSCHs≥timeDurationForQCL
Case 1-1: tci-PresentInDCI enabled
Single QCL assumption based on the indicated single TCI state is applied for all scheduled PDSCHs
Case 1-2: tci-PresentInDCI disabled
QCL assumption of the single DCI scheduled multi-PDSCHs is applied for all scheduled PDSCHs
Case 2: PDSCH scheduling offset for any scheduled PDSCH<timeDurationForQCL
Case 2-1: Single QCL assumption is applied for all scheduled PDSCHs
Case 2-2: multiple QCL assumptions are applied

This disclosure can extend and apply the default beam selection rule defined for single PDSCH scheduling case in clause 5.1.5 of TS 38.214 (henceforth referred to as Rel. 15/16 rule). As per this rule: for a PDSCH with offset less than timeDurationForQCL, the UE will use as default beam the spatial beam used to receive symbols on monitoring occasion(s) in the latest monitored slot (at or prior to the one containing PDSCH) that are associated with the CORESET of lowest ID among all those monitored in that slot. Consequently, applying the extended default beam selection rule the PDSCH (if any) that have offsets smaller than “timeDurationForQCL” can be received by the UE with different RX beams. Thus, any beam selection rule built upon the extended default beam selection rule falls under Case 2-2 of the framework stated above. All embodiments presented below can also be used with an alteration which has the latest monitored slot (prior to the one containing PDSCH).

At least in the single TRP case, there may be a single optimized receive (RX) beam can potentially realize a better signal-to-interference-plus-noise ratio (SINR) at the UE (and hence a better performance). This latter performance could have been achieved for an ideal UE implementation that can instantly process any DCI intended for it, prepare the RX beam (spatial QCL) conveyed via a TCI in that DCI, which then is immediately applied by the UE for all scheduled PDSCHs. In addition, there can be other advantages of ensuring that a single beam is used by the UE to receive all its PDSCH slots. These include improved channel estimation and to some extent simpler AGC control setting and improved MCS determination. One option towards realizing the above ideal performance obtained with a single optimized RX beam is to redefine a default beam selection rule for FR 2-2. This default beam would be used to receive all symbols up to timeDurationForQCL and for all subsequent PDSCH symbols, if any PDSCH had offset less than timeDurationForQCL. Indeed, this default beam could be independently configured from the beams configured for the CORESETs monitored by the UE. However, to be effective and adapt to the UE's changing channel conditions, this default beam should then be sufficiently dynamically configurable. This of course entails more signaling which has to then be precisely defined. Moreover, the original actual spatial RX beam preparation related and beam switching related capabilities of that UE must be respected.

Another option for default beam selection at the UE, which entails a smaller signaling footprint and also aims to apply a single beam (single QCL assumption) over all scheduled PDSCH, is one that is derived by the UE using Rel. 15/16 selection rules applied on its first scheduled PDSCH slot. In other words, the UE identifies the first slot containing PDSCH scheduled for it by a triggering DCI and then determines a beam by applying Rel. 15/16 rules for that slot. Then, this beam is retained as the common beam (single QCL-D assumption) for all slots containing PDSCH symbols scheduled by that DCI. However, there is an ambiguity in this beam selection rule since the UE does not know the exact location of its first PDSCH slot prior to decoding its DCI. Indeed, the offset K0 of the first slot containing PDSCH (as well as offset of any other scheduled PDSCH slot) is dynamically indicated via an index that is included in the DCI (for instance DCI format 1_1) and which identifies a row of a time domain resource allocation (TDRA) table.

Another relevant factor that must also be considered, given the fact that timeDurationForQCL can be 4 or 8 slots for 480 kHz and 8 or 16 slots for 960 kHz, is the possibility that one or more PDCCH monitoring occasions are configured for a UE within a duration of timeDurationForQCL symbols from a prior PDCCH monitoring occasion. In any such scenario, the UE should be unambiguously able to determine a slot index on which it should apply Rel. 15/16 rule in order to obtain a default beam.

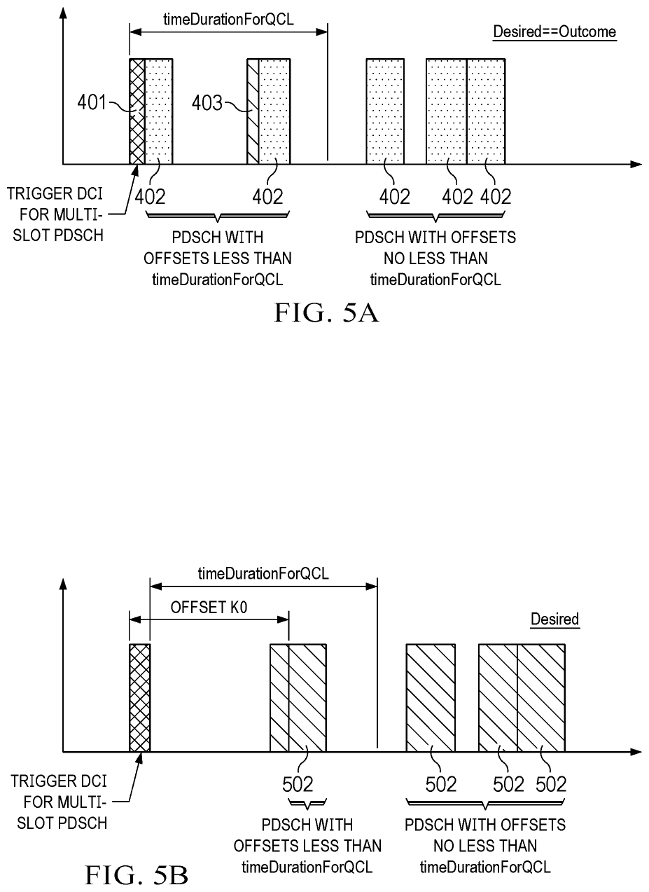

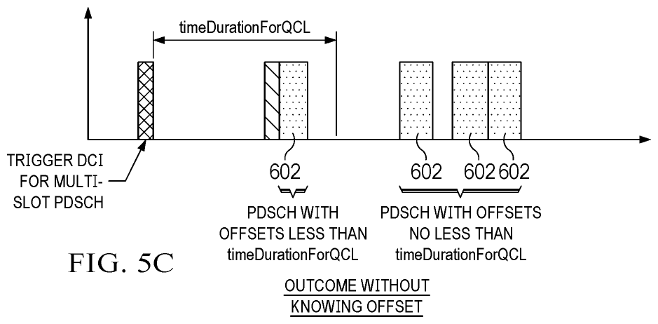

This is depicted via FIG. 5A, FIG. 5B, and FIG. 5C where it is assumed that first PDSCH scheduling offset is less than timeDurationForQCL. Recall that PDSCH allocation in a slot can be of few symbol durations. Moreover, UE does not know on which slots (and specific symbols within those slots) it has been assigned data before processing its DCI present in a PDCCH monitoring occasion. Indeed, it is only certain that entire DCI including resource allocation symbols would be known only after duration timeDurationForQCL symbols from the PDCCH containing the triggering DCI.

In particular, in FIG. 5A, there are no other PDCCH monitoring occasions between the first scheduled PDSCH slot and the scheduling PDCCH (i.e., the PDCCH containing the triggering or scheduling DCI 401 that is present in the first PDCCH monitoring occasion). Here, the UE estimates that the slot containing its first PDSCH is also the slot with the first PDCCH monitoring occasion (the first occasion 401 in FIG. 5A). Then, applying the Rel. 15/16 rule on its estimated first slot, it adopts the beam used for the first PDCCH monitoring occasion 401 as its default beam and employs it to buffer all symbols except those of the second PDCCH monitoring occasion 403 (recall that the beam to be used for each PDCCH monitoring occasion is known in advance). Consequently, all scheduled PDSCHs prior to timeDurationForQCL (e.g., the first two PDSCH symbols 402 before the end of timeDurationForQCL) are received using the adopted default beam. This is also the behavior desired by the gNB.

On the other hand, in FIG. 5B, the first PDSCH slot follows another PDCCH monitoring occasion with a different corresponding beam (in symbols 502), and it is the gNB's intention for the UE to adopt that beam (in symbols 502) for all its PDSCH slots. However, in absence of any other prior information, as depicted in FIG. 5C, the UE can assume that a PDSCH slot is present after the first monitoring occasion itself, and consequently adopts the beam over all its PDSCH slots (e.g., in symbols 602). The UE simply buffers all its symbols (with offsets smaller than timeDurationForQCL) and processes the ones with its PDSCH after it has decoded the DCI.

There can be an ambiguity in determining default QCL assumption of first PDSCH slot. This disclosure describes several embodiments to avoid this ambiguity and specify several UE default beam selection behaviors.

In the first embodiment, the UE derives QCL assuming first PDSCH slot (i.e., slot containing the first PDSCH transmission occasion scheduled for that UE by the DCI) will always be received after a minimum offset, henceforth referred to as K0_min, from a PDCCH monitoring occasion. K0_min can be specified in the units of slots (in the numerology of the scheduled PDSCH) in which case the UE will determine its estimate of slot containing a first PDSCH transmission occasion as the slot that occurs after an offset K0_min from the one containing the PDCCH monitoring occasion. Alternatively, K0_min can be specified in the units of symbols (in the numerology of the scheduled PDSCH) in which case the UE will determine its estimated slot containing a first PDSCH transmission occasion as the slot that contains the symbol which occurs after an offset K0_min symbols from the last symbol containing the PDCCH monitoring occasion.

Then, the QCL assumption can be derived using any pre-defined rule based on an input slot represented by e.g., a slot index. One example of such a rule is one that selects the QCL assumption of the CORESET with the lowest ID in the most recently monitored slot, on or prior to the given input slot.

Furthermore, K0_min may be explicitly configured by a gNB using radio resource control (RRC) signaling.

K0_min may be referred to as a configured value of the first scheduled PDSCH slot offset so that the slot determined using K0_min as the first scheduled PDSCH slot becomes a configured choice of the first scheduled PDSCH slot, i.e., configured choice of the slot containing PDSCH with the smallest scheduling offset. Scheduling offset of a PDSCH can be defined as the time offset between the last symbol of the scheduling DCI and the first symbol of the scheduled PDSCH.

Alternatively, scheduling offset of a PDSCH can be defined as the time offset between the last symbol of the PDCCH monitoring occasion that contains the scheduling DCI and the first symbol of the scheduled PDSCH.

In one embodiment, the default QCL assumption is derived using a configured choice of the first scheduled PDSCH slot, e.g., configured choice of the slot containing PDSCH with the smallest scheduling offset. The default QCL assumption that is derived for this choice of PDSCH slot, is the same as that specified in Rel-16 for single-PDSCH scheduling when the scheduling offset is less than time DurationForQCL.

In another embodiment K0_min configuration can be made more dynamic via medium access control-control element (MAC-CE) signaling.

In another embodiment, a set of K0_min candidate values can be activated using MAC-CE and then a value from that set can be signaled to a UE via DCI. From that point onwards, the UE will keep using the signaled value until the next update for K0_min value is received, upon which it will switch to the new value.

In an alternate embodiment K0_min is implicitly configured using the TDRA table. The TDRA table contains multiple rows (for example 16 rows) and each row can contain multiple slot locations specified via individual offsets. Out of these the offset for the first slot location from each row can be retrieved. For example, let K0_1, . . . , K0_16 be the first PDSCH slot offsets corresponding to 16 rows. Clearly before decoding the DCI the UE does not which particular row has been chosen and therefore the exact offset of the actual scheduled first PDSCH slot. Then, the UE can obtain K0_min as

$$K0\_min = min \{ K 0 \_ 1 , … , K0\_ 16 \} . In particular , K0\_min may be zero .$$

This K0_min is just computed by the UE for determining the default QCL-D assumption, and the gNB is free to use any row from the configured TDRA table.

In another embodiment, K0_min can always be chosen to be K0_1, i.e., minimal offset from the first row of the TDRA table. Alternatively, the offset of the first slot corresponding to any particular choice of row pre-configured semi-statically by gNB can be used as K0_min.

The UE will know exact scheduling grant once it decodes DCI.

In one embodiment, a K0_min is separately configurable for a UE for each of its search space sets. Recall that each search space set is associated with a single CORESET whereas a CORESET can be associated with multiple search space sets. Each CORESET is associated with a TCI state (association conveyed via RRC signaling) so that the RX beam for receiving CORESET symbol(s) and hence the RX beam for receiving each monitoring occasion of any search space set associated with that CORESET is known to the UE. A UE can have up to 10 search space sets and up to 3 CORESETs configured per bandwidth part (BWP). Therefore, for each PDCCH monitoring occasion (MO) of a search space set, using its configured K0_min the UE will determine the slot where it expects the first PDSCH, scheduled by a DCI intended for it in that PDCCH MO, to be and from that estimated slot the UE will determine a default QCL assumption.

In another embodiment, a K0_min that is configurable for a UE for one or more of its search space sets can be a negative value. In this case the default beam is determined by a UE using a preceding slot as the input to its pre-defined rule for determining the default beam (default QCL-TypeD assumptions).

In one embodiment, a K0_min is separately configurable for a UE for each PDCCH monitoring occasion of each of its search space sets. Therefore, for each PDCCH MO of a search space set, using its configured K0_min the UE will determine the slot where it expects the first PDSCH, scheduled by a DCI intended for it in that PDCCH MO, to be and from that estimated slot the UE will determine a default QCL assumption. Furthermore, a K0_min that is configurable for a UE for one or more of its PDCCH monitoring occasions can be a negative value. In this case the default beam is determined by a UE using a preceding slot as the input to its pre-defined rule for determining the default beam (default QCL-TypeD assumptions).

In one embodiment, the gNB configures for the UE an estimate of its first PDSCH slot that it must use with each of its PDCCH monitoring occasions (MO), which can be distinct from the actual one indicated in any scheduling DCI that might be present in that PDCCH MO. Then, for any MO that has a CORESET associated with a CSS, the slot offset of the first estimated slot can be set so that the CORESET beam is not selected as the default beam. Such a CORESET will still be monitored using its corresponding beam, but the symbols preceding and succeeding it will use a different default beam. Conversely, for an MO that has a CORESET associated with only USS, the slot offset of the first estimated PDSCH slot can be set so that the CORESET beam is selected as the default beam. This is a way to direct the UE to use the QCL-D of a monitored CORESET as its default beam assumption.

In one embodiment, the slot offset (K0_min) configured for each PDCCH MO in a slot are identical. In this embodiment one offset needs to be configured per slot.

In an extended embodiment, no offset is configured for a slot without any PDCCH MO. For such a slot no default beam is determined. Instead, the default beam used to receive indeterminate symbols in such a slot is the most recently used default beam over a prior slot.

In one more embodiment, the gNB configures for the UE an estimate of its first PDSCH slot that it must use with each of its slots. This estimate can be distinct from the actual one indicated in any scheduling DCI that might be present in a PDCCH monitoring occasion (MO) in that slot. Then, for a slot with an MO that has a CORESET associated with a CSS, the slot offset of the first estimated slot can be set so that that CORESET beam is not selected as the default beam for that slot. Such a CORESET will still be monitored using its corresponding beam but the indeterminate symbols preceding and succeeding it in that slot (if any) will use a different default beam. Conversely, for a slot that only has MO with a CORESET associated to only USS, the slot offset of the first estimated PDSCH slot can be set so that the CORESET beam is selected as the default beam. This is a way to direct the UE to use the QCL-D of a chosen monitored CORESET as its default beam assumption over a slot.

In one embodiment the gNB configured value of the first scheduled PDSCH slot offset, i.e., a configured choice of the slot containing PDSCH with the smallest scheduling offset, is applied. The default QCL assumption derived for this PDSCH slot, is the same as that specified in Rel. 15/16 for single-PDSCH scheduling when the scheduling offset is less than timeDurationForQCL.

In another embodiment, the UE uses offset K0_min to identify a first potential PDSCH transmission slot. Then the UE retrieves the set of activated TCI states for that slot and chooses the TCI state with the lowest codepoint to obtain the QCL assumption for its default beam. Here, each TCI state can identify one or more QCL sources.

UE behavior in any of the aforementioned embodiments: The UE starts buffering symbols following a PDCCH MO using some beam determined as the output of a pre-defined rule which in turn is given as input the slot with offset K0_min from the slot containing the PDCCH MO of interest. One example of such pre-defined rule is the one which yields as output the beam corresponding to the CORESET with the lowest ID in the most recently monitored slot on or prior to its input slot.

In this context, it is noted that certain symbols which occur within timeDurationForQCL from the latest PDCCH MO and need to be received, need not be indeterminate, i.e., beams to be used for receiving/buffering these symbols are already known to the UE. These symbols could be CORESET symbols, or those indicated as containing data or pilots (reference signals) for it by a previous DCI that has been decoded. All such symbols are buffered using respective associated beams. In addition, symbols that have been configured (for instance semi-statically via RRC) as UL symbols for the UE by the gNB are also not indeterminate.

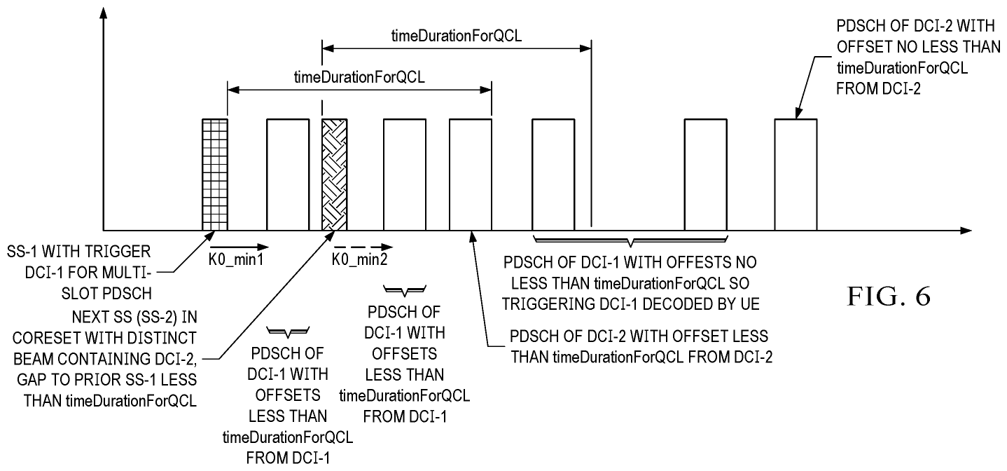

This disclosure also addresses another complication that can arise whenever another PDCCH MO occurs within timeDurationForQCL from a previous PDCCH MO. In such a situation, there can be an ambiguity about which default beam to use: the one determined for the previous MO or the one determined for the latter MO. This situation is depicted in FIG. 6.

In particular, in FIG. 6, there are two monitoring occasions containing two search space sets SS-1 and SS-2, respectively, with configured K0_min1 and K0_min2 which possibly can be distinct. Suppose that these search space sets have distinct corresponding default beams determined by the UE for the slots which are with offsets K0_min1 and K0_min2 from the slots containing SS-1 and SS-2, respectively. There is an ambiguity that arises here because the symbols that occur after the one containing SS-2 and which are within timeDurationForQCL for SS-1 (and hence also for SS-2) are simultaneously required to be received using default beam determined for SS-1 using K0_min1 as well as using default beam determined for SS-2 using K0_min2.

In one embodiment, in any such situation the latter PDCCH MO (most recent monitored SS, which is SS-2 in the above example) takes precedence. This might break the desired single QCL property, but it is beneficial to avoid a complex default beam determination at the UE.

With this precedence in hand, let us examine how default beam assumptions can be influenced by configuring K0_min1 and K0_min2.

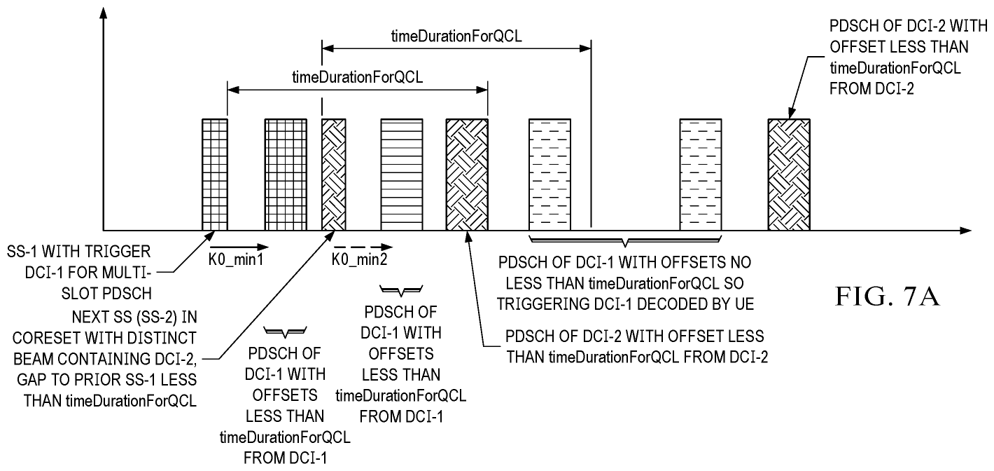

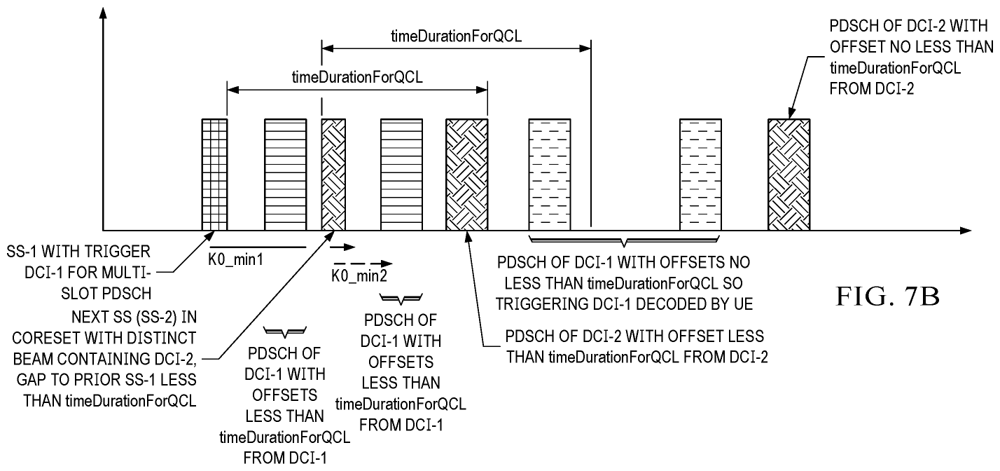

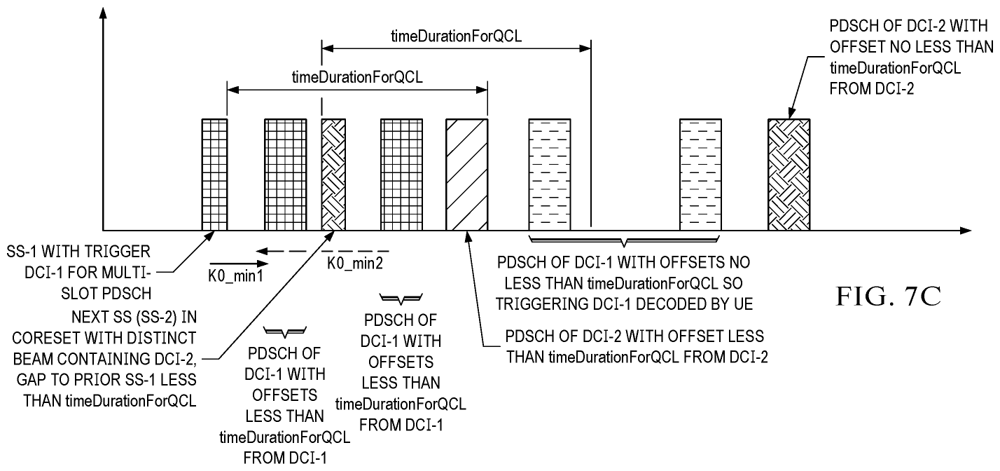

FIG. 7A to FIG. 7C illustrate three examples each with differing (K0_min1, K0_min2) settings.

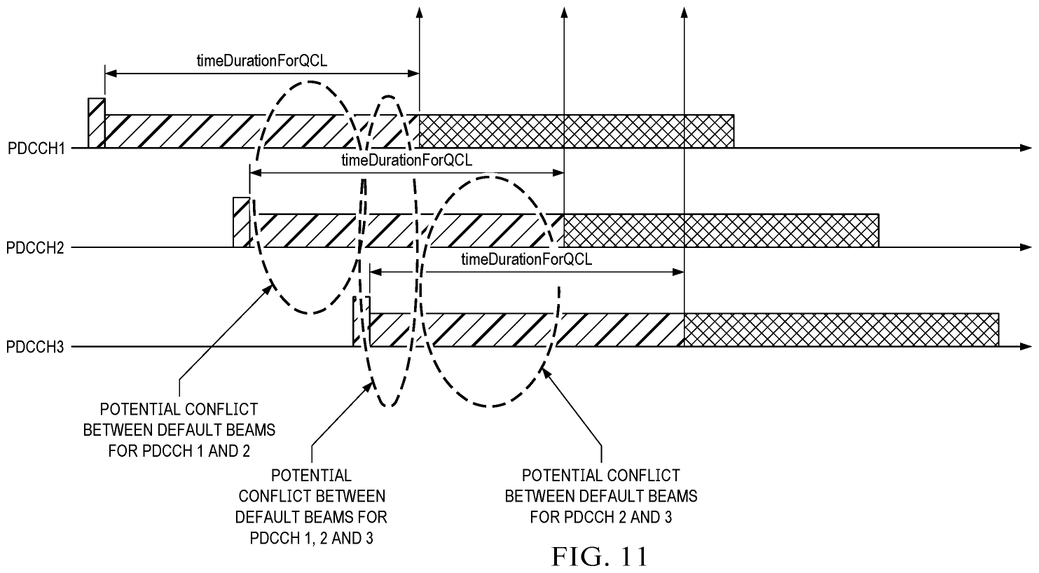

In each case, the default beams for SS-1 and SS-2 are determined using their respective K0_min1 and K0_min2. For all symbols that are within timeDurationForQCL from both the last-symbol containing SS-1 as well as the last symbol containing SS-2, the default beam computed for SS-2 takes precedence. The flow of UE side default beam operation is depicted in FIG. 11. The step of default beam determination/update is the key step. This step is responsive to the K0_min configured for the latest MO (e.g., the latest monitored search space set) from which it determines a candidate default beam. It also considers the latest previously used default beam and a precedence relation between the two beams to determine the updated default beam which can either be the candidate default beam or the latest previously used default beam.

Moreover, UE behavior for the PDSCH symbols that are not indeterminate can also have variations.

In one embodiment, for all PDSCHs triggered by a DCI in SS-1 (referred to as DCI-1) that occur after offset of timeDurationForQCL from the slot containing SS-1, UE can apply the indicated TCI-state in DCI-1 (since it is decoded by the UE prior to receiving those symbols) or if such TCI field is absent, UE can apply the TCI state corresponding to the CORESET containing SS-1. Analogous comment applies to PDSCH triggered by a DCI in SS-2 (referred to as DCI-2) that occur after offset of timeDurationForQCL from the last symbol containing SS-2.

In another embodiment, the default beam computed for SS-1 can be applied to receive symbols of all such PDSCHs indicated in DCI-1 and the default beam computed for SS-2 to receive all such PDSCHs indicated in DCI-2.

In yet another embodiment, the default beam computed for SS-2 can be applied to receive symbols of all such PDSCH indicated in DCI-1 and the same default beam computed for SS-2 to receive all such PDSCH indicated in DCI-2.

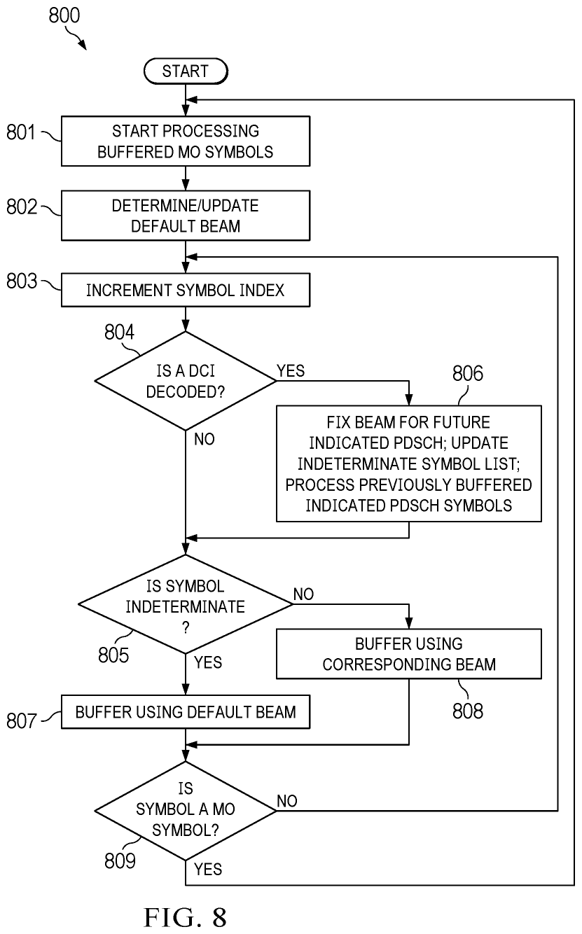

Additional embodiments that can resolve the default beam selection ambiguity are disclosed in the following paragraphs. Flowchart 800 in FIG. 8 illustrates the UE side default beam based operation. The UE starts processing buffered monitoring occasions in step 801 to determine and/or update the default beam as shown in step 802. In step 803, the UE increments the symbol index and determines if a DCI is decoded in step 804. If a DCI is decoded, then the UE fixes a beam for future indicated PDSCH, updates an indeterminate symbol list, and processes previously buffered indicated PDSCH symbols as indicated in step 806. If a DCI is not decoded or step 806 as previously described is completed, the UE determines if the symbol is indeterminate in step 805. If the symbol is indeterminate, the UE buffers the symbol using the default beam in step 807. If the symbol is not indeterminate, the UE buffers the symbol using the beam corresponding to the symbol as shown in step 808. The UE then determines if the symbol is an MO symbol in step 809. If the symbol is an MO symbol, the UE starts processing buffered symbols in step 801. If the symbol is not an MO symbol, the UE increments the symbol index as shown in step 803.

In one embodiment, the UE shall expect that the time gap in symbols between any PDCCH consecutive monitoring occasions with UE-specific search space sets (USSs) is no less than its signaled timeDurationForQCL for that sub-carrier spacing. In this case, a UE will be able to decode the DCI in a USS prior to the next USS it is expected to receive.

In another embodiment, the UE shall expect that the time gap in symbols between any consecutive monitoring occasions with UE-specific search space sets (where those monitoring occasions are in CORESETS associated with distinct beams) is no less than its signaled timeDurationForQCL for that sub-carrier spacing. In this case a UE will be able to decode the DCI in a USS prior to the next USS (with distinct beam) is expected to receive.

However, in both these embodiments there can be a common search space set (CSS) in a CORESET that the UE must monitor, symbols of which are within timeDurationForQCL symbols from a prior USS.

In either embodiment, a default beam determined using the K0_min configured for the CSS can be applied to receive the indeterminate symbols succeeding those of the CSS. By appropriately setting K0_min configured for the CSS, an immediate advantage is that the gNB can prevent the UE from employing the wider beam of the CORESET associated to CSS (for example CORESET-ID 0) to receive its PDSCH, while also being able to flexibly schedule those PDSCH. Here, it is important to note that CSS can contain a DCI format 1_0 that can schedule single PDSCH for the UE. Under legacy operation, the UE will receive this PDSCH using the wider beam associated with the CORESET, which has lower beamforming gain. Conversely by accordingly configuring K0_min of USS, the gNB can ensure that the data scheduled by a DCI in the USS can be received by the wider beam associated with the CSS, which can improve reliability or robustness.

Additional embodiments that can resolve the default beam selection ambiguity problem are disclosed in the following paragraphs.

In one embodiment, each CORESET that is assigned to the UE is further configured with a binary flag, referred to here as ValidforDefaultIndex flag. This flag can take values {0} or {1}. The configuration is done in a UE specific manner. This means that a CORESET that is assigned to one UE can be configured with ValidforDefaultIndex=1 whereas that same CORESET can be assigned to another UE but can be configured with ValidforDefaultIndex=0 for that UE.

In one embodiment, the default beam for receiving indeterminate symbols in a slot n will be determined using the QCL parameters of the CORESET associated with a monitored search space with the lowest controlResourceSetId (CORESET ID) among CORESETs, which are configured with ValidforDefaultIndex=1, in the latest slot (at or prior to the slot n) in which one or more CORESETs associated with ValidforDefaultIndex=1, within the active BWP of the serving cell, are monitored by the UE.

At least one CORESET configured for the UE has ValidforDefaultIndex=1. The setting of ValidforDefaultIndex for each configured CORESET of a UE can be changed using RRC signaling.

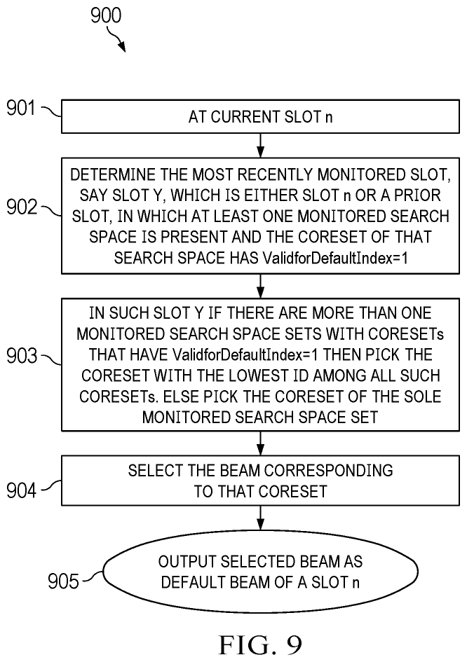

A flowchart 900 of the embodiment for default beam selection described above is depicted in FIG. 9. In step 902, the UE determines the most recently monitored slot, designated as slot Y, which is either the current slot, n, or a prior slot. If no slot Y containing at least one CORESET of monitored search space set with ValidforDefaultIndex=1 is found, then the selected default beam can be set to a pre-configured choice. In step 903, if slot Y contains only one monitored search space set with a CORESET having ValidforDefaultIndex=1, then the UE selects the only CORESET. If slot Y contains more than one monitored search space set with CORESETs that have ValidforDefaultIndex=1, then the UE selects the CORESET with the lowest ID of all such CORESETs, as shown in step 903. The UE then selects the beam corresponding to the selected CORESET, as shown in step 904, and outputs the selected beam as the default beam of a slot n, as shown in step 905.

The symbol reception stage in this embodiment is described next. At each slot n, the symbol reception step follows default beam determination step for that slot n.

The UE receives all indeterminate symbols in slot n using the default beam determined for that slot n.

The UE receives non-indeterminate and non-PDSCH symbols in slot n using corresponding known beams.

Non-indeterminate and PDSCH symbols in slot n are received using indicated beam in the scheduling DCI if that scheduling DCI indicates a beam. Otherwise, non-indeterminate and PDSCH symbols are received using the beam of the MO containing the scheduling DCI.

In another embodiment non-indeterminate and PDSCH symbols in slot n can also be received using a prior default beam that was used to receive previous PDSCH symbols that were scheduled by the same scheduling DCI. If no such prior default beam exists, then the behavior described in paragraph above is adopted.

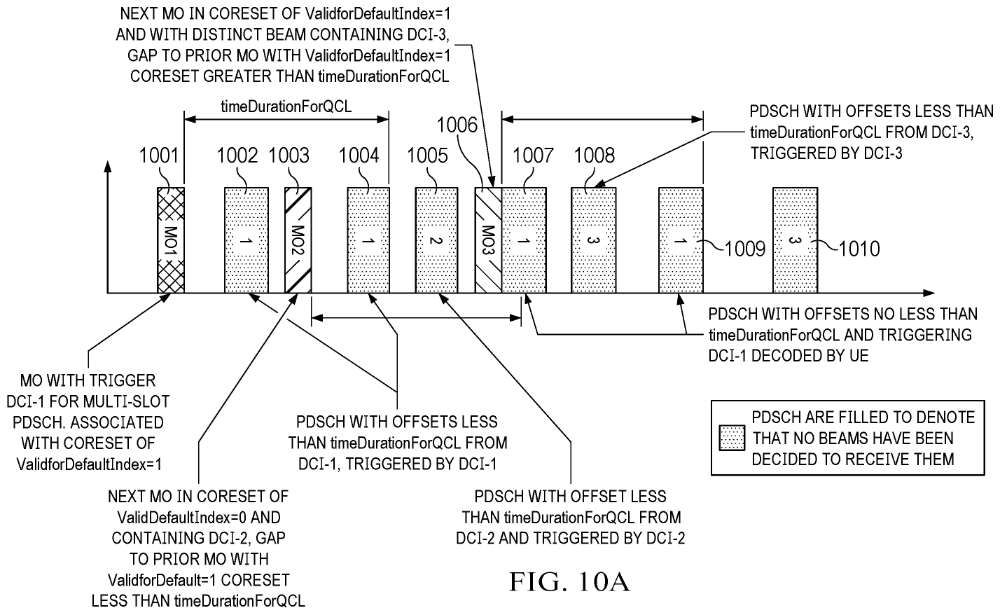

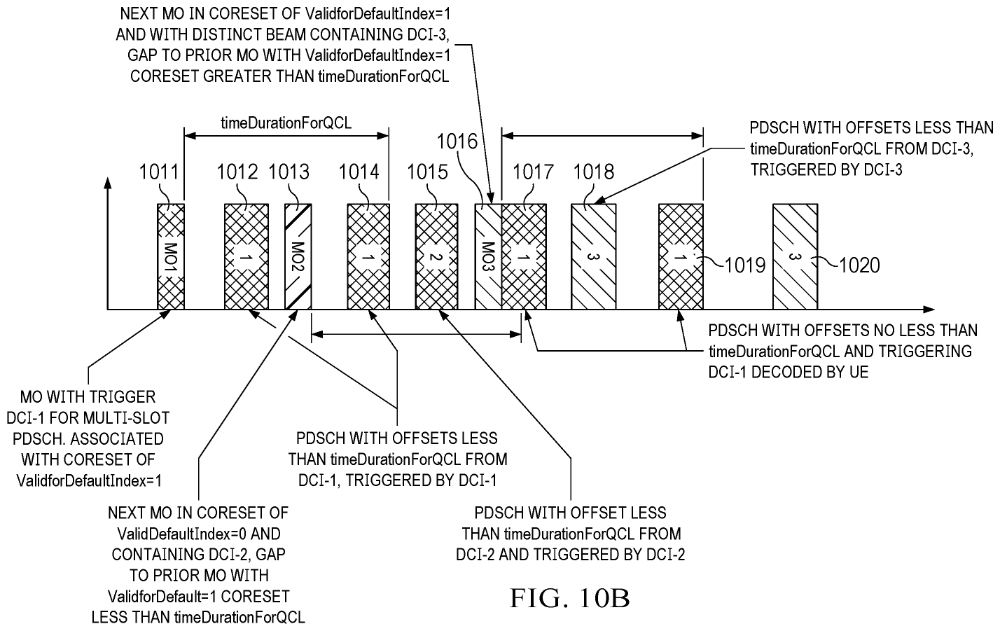

The operation of the default beam selection and symbol reception stages are described using schematics in FIG. 10A and FIG. 10B.

In FIG. 10A, a scheduling allocation is presented without any beam determined for the scheduled PDSCH.

In FIG. 10B, the same scheduling allocation is presented but in which beams to receive PDSCH have been determined using the proposed solution in FIG. 9.

In FIG. 10B, PDSCH are number labelled to denote the beams used to receive them. The labelled number of a PDSCH denotes that the beam used to receive it is the one corresponding to receive an MO of the same labelled number.

In FIG. 10B, a PDCCH monitoring occasion (MO) labeled MO1 contains DCI-1 that schedules multiple PDSCH labeled 1. The CORESET of the SS corresponding to MO1 has flag ValidforDefaultIndex=1. Therefore, indeterminate symbols following MO1 (and other indeterminate symbols in the slot containing MO1) are received using the beam corresponding to CORESET with the lowest index among CORESETs of monitored SS that each have ValidforDefaultIndex=1, in the latest slot that contains at-least one monitored SS with such a CORESET. This means that in Figure-valid2 the beam of the CORESET of MO1 is used to receive indeterminate symbols following MO1, which include the first two PDSCH scheduled by DCI-1. The latter two PDSCH are labeled 1 and marked in green to highlight that they are received using the same beam as CORESET of MO1. The next MO, MO2, is associated with a CORESET that has ValidforDefaultIndex=0. Consequently, indeterminate symbols following MO2 are also received with the beam of the CORESET of MO1. This is because all such symbols are in slots for which the CORESET with the lowest index among CORESETs of monitored SS in the latest slot that each have ValidforDefaultIndex=1 remains the one in MO1. Therefore, the PDSCH scheduled by DCI-2 labeled as 2 (1015) is also received using beam of CORESET of MO-1 and hence is also crosshatch shaded even though the beam of MO-2 is distinct. Consider MO-3 where the CORESET in MO3 has ValidforDefaultIndex=1. Then, since for the slot containing MO3 the lowest index among CORESETs of monitored SS in the latest slot that each have ValidforDefaultIndex=1 is the CORESET in MO-3, the indeterminate symbols 1018 and 1020 following MO-3 (as well as other indeterminate symbols on the slot containing MO3) are received with the beam corresponding to MO-3 which is diagonal shaded. Thus, the PDSCHs 1018 and 1020 labeled as 3 (which are PDSCH scheduled by DCI-3 in MO-3) are also diagonal shaded.

It is to be noted that the first PDSCH scheduled by DCI-3 is indeterminate when it is received so it is received using the determined default beam (beam of CORESET of MO-3). The second PDSCH scheduled by DCI-3 in MO-3 is not indeterminate when it is received since by then UE has decoded DCI-3. To preserve single QCL assumption, it is still received by UE with beam of CORESET of MO-3 since the first PDSCH scheduled by DCI-3 has already been received with that beam. An analogous comment applies with respect to the third and fourth PDSCH scheduled by DCI-1 in MO-1 since they are not indeterminate and first PDSCH scheduled by DCI-1 has already been received using the beam of MO-1.

In another embodiment the PDSCH which are not indeterminate can be received using the beam indicated by a TCI field in the scheduling DCI, if such a field is present. This means that if DCI-1 has a TCI field in it then the third and fourth PDSCH blocks labeled as 1 will be received using the beam (implicitly) indicated by the TCI field which can be different than the beam of the CORESET of MO-1. Similarly, if DCI-3 has a TCI field, then the second PDSCH following MO-3 that is labeled 3 will be received using beam indicated by that TCI field instead of the one corresponding to CORESET of MO-3. Same would apply to PDSCH scheduled by DCI-2 in MO-2 if such PDSCH with offsets greater than or equal to timeDurationForQCL were present.

In one embodiment, the UE may be configured to receive DCI capable of scheduling multiple PDSCHs by configuring a higher layer parameter [pdsch-TimeDomainAllocationListForMultiPDSCH-r17]. When the UE is configured with higher layer parameter [pdsch-TimeDomainAllocationListForMultiPDSCH-r17] and the DCI schedules one or more PDSCH(s), and the time offset between the reception of the DL DCI and any PDSCH(s) is less than a threshold timeDurationForQCL, if applicable, for the QCL assumption used for any PDSCH with offset less than threshold timeDurationForQCL:

The UE may assume that the demodulation reference signal (DMRS) ports of PDSCH are quasi-colocated with the RS(s) with respect to the QCL parameter(s) used for PDCCH quasi co-location indication of the CORESET associated with a monitored search space with the lowest controlResourceSetId among CORESETs, which are configured with ValidforDefaultIndex=1, in the latest slot in which one or more CORESETs associated with ValidforDefaultIndex=1 within the active BWP of the serving cell are monitored by the UE.

In one embodiment, the gap between any two monitoring occasions corresponding to CORESETs with ValidforDefaultIndex=1 is greater than timeDurationForQCL.

In another embodiment, the gap between any two monitoring occasions corresponding to CORESETs with ValidforDefaultIndex=1 and which are associated with distinct QCL-TypeD is greater than timeDurationForQCL.

In one embodiment, modified Rel. 15/16 rule for single-PDSCH scheduling is applied when the scheduling offset of any PDSCH is less than timeDurationForQCL. The modification only applies the original Rel. 15/16 rule over a pool of CORESETs that are further indicated to be valid for default beam determination instead of all CORESETs configured for that UE.

In one embodiment, a slightly changed the Rel. 15/16 rule is used by the UE. Here, the gNB configures CORESETs for the UE and additionally also indicates whether each configured CORESET is valid for default beam computation or not (via a bit per configured CORESET). Then, to determine the default beam for a slot, the UE simply determines the latest slot (at or prior to slot of interest) in which it monitors at least one CORESET indicated to be valid, and among the CORESETs indicated to be valid in the latest slot, selects the lowest ID CORESET. The QCL parameters of the selected CORESET yield the default beam.

In another embodiment, a slightly changed the Rel. 15/16 rule is used by the UE. Here, the gNB configures CORESETs for the UE and additionally also indicates whether each configured CORESET is valid for default beam computation or not (via a bit per configured CORESET). Then, to determine the default beam for a slot, the UE simply determines the latest slot (prior to slot of interest) in which it monitors at least one CORESET indicated to be valid, and among the CORESETs indicated to be valid in the latest slot, selects the lowest ID CORESET. The QCL parameters of the selected CORESET yield the default beam.

In a different embodiment, the UE is not expected to receive multiple PDCCHs (containing multiple DCIs) that schedule interleaved data in time. In other words, a second PDCCH (second DCI) received after a first PDCCH (first DCI) cannot schedule data transmission before the end of data transmission scheduled by the first PDCCH (DCI). In another embodiment, the second PDCCH (DCI) cannot schedule data before the HARQ (AC/NACK) transmission corresponding to the data scheduled by the first PDCCH (DCI).

In yet another embodiment, the UE is not supposed to receive two PDCCH (two DCIs) scheduling data transmissions where the time interval between the two consecutive PDCCH (DCI) is shorter than the timeDurationForQCL. If such thing happens the second PDCCH (DCI) is not considered.

In one embodiment, the UE is not supposed to receive two PDCCH (two DCIs) that both schedule multi-slot PDSCH transmissions, and where the time interval between the two consecutive PDCCH (consecutive DCIs) is shorter than the timeDurationForQCL. If such thing happens the second PDCCH (DCI) is not considered.

In another embodiment, the UE is not supposed to receive two PDCCH (two DCIs) at-least one of which schedules multi-slot PDSCH data transmission, and where the time interval between the two consecutive PDCCH (consecutive DCIs) is shorter than the timeDurationForQCL. If such thing happens the second PDCCH (DCI) is not considered.

In another embodiment, the UE is not supposed to receive two PDCCH (two DCIs) at-least one of which schedules multi-slot PDSCH data transmission, and where the time interval between the two consecutive PDCCH (consecutive DCIs) is shorter than the time DurationForQCL. If such thing happens the first PDCCH (DCI) is not considered.

In a different embodiment, there are separate slot groups or symbols groups (patterns) for control PDCCH (DCI) monitoring and slot groups or symbols groups (patterns) for data transmission, which may or may not repeat periodically. When they are periodically repeated the periods for control slots (symbols) and data slots (symbols) may or may not be the same.

In one embodiment, the slots/symbols groups for monitoring PDCCH are apart at least time DurationForQCL, and do not overlap. In other words, if they are periodic, the repetition period is greater or equal than timeDurationForQCL.

In a different embodiment, there is a minimum time interval (such as timeDurationForQCL) between a group of slots/symbols employed for control monitoring (PDCCH) and the corresponding group of slots/symbols employed for data transmission.

In one embodiment, when there are multiple overlaps between timeDurationForQCL spans corresponding to consecutive PDCCH MO, the default beam for buffering is always corresponding to the oldest PDCCH MO. In FIG. 11, it means that the buffering is done with the default (corresponding) beam for PDCCH1 until the end of its timeDurationForQCL, then using, as the default beam, the beam corresponding to PDCCH2 (in the overlap region between one from PDCCH2 until end of its timeDurationForQCL and the one from PDCCH3 until end of its timeDurationForQCL), and finally using as default beam the beam corresponding to PDCCH3.

In a different embodiment, the default beam could be the beam corresponding to the latest PDCCH MO. Note that such situations should be in general avoided because they can lead to potential loss of PDSCH in the overlapping timeDurationForQCL (due to non-optimized choice of receive beams) when the exact time of PDSCH transmission is not known. However, if there are interlaced in time data transmissions during such overlapping time DurationForQCL regions and the symbols of those transmissions are known, the receiving UE may switch beam to receive data and in between switch back to a default beam.

Another issue is that the under certain search space set and CORESET configurations, it is possible that the beam of the lowest ID CORESET is not the most recently used beam among all CORESET beams used over monitoring occasions in the most recently monitored slot. Considering such configurations, in one embodiment another default beam selection rule given a choice of first PDSCH slot could be for the UE to select the most recently used CORESET beam employed over the prior most recent monitoring occasion in the latest monitored slot, on or prior to that choice of first PDSCH slot.

This disclosure describes embodiments considering scenarios in which multiple transmission points (TRPs) transmit to a UE.

One scenario is a case in which a single DCI schedules multiple PDSCH, wherein in each PDSCH transmit occasion, two TRPs transmit simultaneously to a common UE. This corresponds to a joint transmission from two different transmission points to a single UE over each of the scheduled PDSCH.

The receive beams that must be used by the UE are conveyed via a TCI field which includes two TCI states (one for each TRP). The states indicated by TCI field can be applied by the UE whenever the offset between scheduling PDCCH and the PDSCH is no less than timeDurationForQCL.

In one embodiment, if the offset between scheduling PDCCH and the first PDSCH slot is less than timeDurationForQCL, all aforementioned embodiments to determine a first PDSCH slot via a configurable K0_min apply. The first slot so determined can be the input to a pre-defined rule that outputs a pair of default beams (pair of QCL assumptions) that the UE can use to receive and buffer at-least indeterminate symbols. An example of such rule can be one that chooses as output, the TCI codepoint with the lowest ID among all TCI codepoints (that have been activated for that UE for the input slot) having two distinct TCI states. Another rule can be one that chooses as output, the TCI codepoint with the lowest ID among all TCI codepoints (activated for that UE) having two distinct TCI states.

This disclosure describes embodiments considering scenarios in which cross-carrier scheduling is performed by the gNB to schedule the UE.

In this setting the PDCCH monitoring occasions and the scheduled PDSCH are on different component carriers and have a different sub-carrier spacing (SCS). For example (PDCCH, PDSCH) pair of SCSs in kHz can be (120, 480) or (120, 960) or (480, 960).

In one embodiment K0_min can be configured for each PDCCH monitoring occasion in the PDSCH numerology (in terms of number of PDSCH slots) and the UE determines a slot for an estimated (hypothesized) first PDSCH transmission in PDSCH numerology. Using this the UE determines in PDCCH numerology the latest slot prior (in time) to the estimated PDSCH slot or a slot that contains it (each slot in PDCCH numerology is larger than the one in PDSCH numerology). Rel. 15/16 rule is applied on this determined slot to obtain the default beam.

In another embodiment, K0_min can be for each PDCCH monitoring occasion in the PDCCH numerology in which case the UE determines a slot in the PDCCH numerology that is at an offset K0_min from the one containing the PDCCH monitoring occasion. Rel. 15/16 rule may be applied on this determined slot to obtain the default beam.

This disclosure considers the beam switch gap. A safe solution to satisfy beam switch delay constraint for FR2-2 is for the gNB to ensure that no UE will need to perform beam switching in adjacent OFDM symbols in both 480 kHz and 960 kHz SCS. In other words, purely via scheduling gNB ensures there is always a symbol gap whenever a beam switch would otherwise be needed in each of these SCS (for example in the aforementioned instances). This gap symbol is then regarded as a symbol by that UE on which nothing intended for it would be transmitted by the gNB nor is it expected to transmit anything.

However, this solution has two drawbacks. Firstly, it precludes taking advantage of UE implementations that allow for faster beam switch. A more efficient solution could be some signaling to indicate UE beam switch capability, which would then allow gNB to decide whether to provision a symbol gap (to accommodate beam switch) in a UE specific manner. Clearly if this capability is signaled, then a UE should not be expected to perform a beam switch at a rate exceeding its signaled capability.

Secondly, relying on scheduling alone may be limited by the worst-case and can rule out choices/configurations, where even only one occasion presents an adjacent beam switch to a UE without that capability. A better alternative is to retain such configurations but instead specify UE behavior for the occasions where the gNB schedules adjacent symbol beam switching exceeding its capability. For instance, in such a scenario the UE can be mandated to prioritize decoding its scheduled PDCCH symbols and refrain from receiving other transmissions intended for the UE that require a beam switch violating its indicated capability.

This behavior will indeed be in line with existing Rel. 16 behavior which is underlined below in the paragraph taken from clause 5.1.5 of TS 38.214 summarized below (with most relevant parts underlined for emphasis):

“Independent of the configuration of tci-PresentInDCI and tci-PresentDCI-1-2 in
RRC connected mode, if the offset between the reception of the DL DCI and the
corresponding PDSCH is less than the threshold timeDurationForQCL and at least
one configured TCI state for the serving cell of scheduled PDSCH contains qcl-Type
set to ‘typeD’,
- the UE may assume that the DM-RS ports of PDSCH of a serving cell are quasi
co-located with the RS(s) with respect to the QCL parameter(s) used for PDCCH
quasi co-location indication of the CORESET associated with a monitored search
space with the lowest controlResourceSetId in the latest slot in which one or more
CORESETs within the active BWP of the serving cell are monitored by the UE.
In this case, if the qcl-Type is set to ‘typeD’ of the PDSCH
DM-RS is different from that of the PDCCH DM-RS with which they
overlap in at least one symbol, the UE is expected to prioritize
the reception of PDCCH associated with that CORESET. This also
applies to the intra-band CA case (when PDSCH and the CORESET
are in different component carriers).”

In light of the beam switching time gap, such a rule specified in FR 2-1 also needs to be extended in FR 2-2 to the case where two different search space sets associated with different CORESETs having distinct active TCI states (distinct beams or QCL-TypeD properties) are assigned to a UE. Further, at-least a pair of monitoring occasions (one from each search space set) are non-overlapping but adjacent. Then, in this case the UE is required to perform reception and beam switch over adjacent symbols and when such a switch violates its capability, then a priority or precedence relation must be known to the UE so that it can perform the switching accordingly.

For the overlapping monitoring occasions scenario a precedence relation has been defined previously in TS 38.213 clause 10.1, as captured in excerpt below (with the relevant parts underlined for emphasis).

If a UE
- is configured for single cell operation or for operation with carrier
aggregation in a same frequency band, and
- monitors PDCCH candidates in overlapping PDCCH monitoring
occasions in multiple CORESETs that have same or different
QCL-TypeD properties on active DL BWP(s) of one or more cells
the UE monitors PDCCHs only in a CORESET, and in any other
CORESET from the multiple CORESETs having same QCL-TypeD
properties as the CORESET, on the active DL BWP of a cell
from the one or more cells -
the CORESET corresponds to the CSS set with the lowest index
in the cell with the lowest index containing CSS, if any;
otherwise, to the USS set with the lowest index in the
cell with lowest index

More generally, in such scenarios UE can be mandated to prioritize receiving one type of transmission that the UE is supposed to receive over the other.

Analogous to the overlapping PDCCH/PDSCH or PDCCH/PDCCH with different QCL-TypeD situation in FR2-1, in FR2-2 a precedence relation is necessary for UEs incapable of adjacent symbol reception and beam switching.

In one embodiment, for some specific SCS such as both 480 kHz and 960 kHz SCS, UE is not expected to be able receive downlink data or control channel or reference signals with different QCL-TypeD properties on adjacent symbols within a slot if that violates its signaled beam switch capability or if this capability is not signaled.

In another embodiment, for some specific SCS such as both 480 kHz and 960 kHz SCS, UE is not expected to be able receive downlink data or control channel or reference signals with different QCL-TypeD properties on adjacent symbols within a slot if that violates its signaled beam switch capability. The UE is assumed to be capable of adjacent symbol beam switching if this capability is not signaled.

In one embodiment, precedence relations as defined in Table 1 are used by a UE incapable of adjacent symbol reception and beam switch, to determine which symbol to switch on, for all instances entailing adjacent symbol reception and beam switch. Here, the switch is done on the lower priority symbol immediately preceding a higher priority symbol, from the corresponding beam of the lower priority symbol to the corresponding beam of the higher priority symbol. Here and in the following, this disclosure uses priority of a symbol to imply priority of the signal (or signal type or channel) that the symbol is carrying (or contains). Indeterminate symbols correspond to indeterminate signals (or channels) since the signals they carry are not known to the UE but might be intended for that UE. Beams corresponding to indeterminate symbols can be determined by the UE using the methods provided previously in this disclosure.

In one embodiment priority of a symbol can be based on its corresponding signal as well as corresponding beam.

In another embodiment, precedence relations as defined in Table 2 below are used by a UE incapable of adjacent symbol beam switch, to determine which symbol to switch on for all instances entailing adjacent symbol reception and beam switch. Here, the switch is done on the lower priority symbol immediately preceding a higher priority symbol, from the corresponding beam of the lower priority symbol to the corresponding beam of the higher priority symbol.

In one embodiment, a UE based on its beam switch time gap already knows that it is incapable of adjacent symbol reception and beam switch over symbols in an SCS. This UE will follow precedence relations to determine which symbol to switch on for all instances entailing adjacent symbol reception and beam switch.

In another embodiment, the gNB configures the UE to assume that it is incapable of adjacent symbol reception and beam switch over symbols in a SCS. This UE will then follow precedence relations to determine which symbol to switch on for all instances entailing adjacent symbol reception and beam switch. Such configuration can be done via RRC or MAC-CE signaling.

More generally switching is done on the lower priority symbol immediately preceding a higher priority symbol, from the corresponding beam of the lower priority symbol to the corresponding beam of the higher priority symbol, where the symbol priority is known in advance and can depend on the type of expected transmission in that symbol (for instance, control symbols may have higher priority than data symbols, or symbols containing reference signals may have higher priority than data symbols or some specific directions may have higher priority over others, or some type of control higher priority than others, CSS vs USS for instance). The symbol priority may be changed for example via RRC or MAC channel estimation (CE).

In one embodiment, when two symbols have the same priority, the time precedence can be considered, for instance always switch in the second symbol, etc.

In one embodiment, the precedence relation is to mandate the UE to prioritize symbols corresponding to PDCCH monitoring occasions and switch on preceding and subsequent symbols whenever a switch (and/or symbol gap) is needed, and those symbols are not associated with any PDCCH monitoring occasion. In such case, the switching is done on one or more PDCCH monitoring occasions then priority can be given to a CORESET with lower ID so that switching (if done) occurs on symbols in monitoring occasion corresponding to CORESET of lower priority (higher ID).

In another embodiment, any PDSCH whose one or more symbols collide with symbols that are semi-statically configured as UL symbols for the UE, is not received by the UE and ignored for the purpose of QCL (default beam) determination. The remaining symbols of that PDSCH (which do not collide with the UL symbols) can be regarded as gap symbols. Additionally, as an option, one or more of the semi-statically configured UL symbols in which UE is not scheduled to transmit or does not transmit can also be regarded as gap symbols.

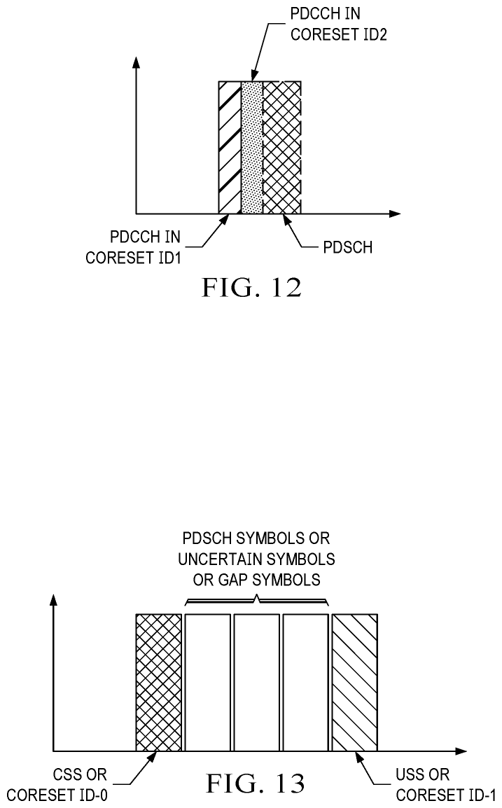

This disclosure next considers a case when there can be a race condition or a contention between precedence rules by considering the case where there are consecutive symbols belonging to two distinct search spaces that must be monitored by the UE and those are associated with different CORESETs. Further, the CORESET symbols are followed or preceded by assigned PDSCH. Such a situation can arise when the UE is assigned a common search space (CSS) followed by user-specific search space whose symbols are contiguous, further followed or preceded by assigned PDSCH symbols. In particular, consider the scenario depicted in FIG. 12.

In FIG. 12, suppose CORESET ID1 and CORESET ID2 represent two CORESETs that have search space sets that must be monitored by the UE. Moreover, suppose that these two CORESETs are associated with different beams. The last symbol of the second CORESET is followed by one or more PDSCH symbols. Note that all CORESET symbols illustrated in FIG. 12 are contiguous without any gaps (i.e., symbols that are not required to be received by UE of interest).

In one embodiment, the UE is required to give precedence of CORESET having lower ID (CORESET with ID=1 or simply CORESET-1). However, upon satisfying precedence of CORESET-1, at-least one symbol of CORESET-2 will be lost whenever a switch is done on one of those symbols, the UE therefore avoids receiving symbols of CORESET-2 and instead utilizes one or more of those symbols to switch if needed to the beam corresponding to the PDSCH symbol following CORESET-2.

This behavior is captured by the following text: If a UE, (1) is configured for single cell operation or for operation with carrier aggregation in a same frequency band, and (2) monitors PDCCH candidates in overlapping or adjacent PDCCH monitoring occasions in multiple CORESETs that have same or different QCL-TypeD properties on active DL BWP(s) of one or more cells, then the UE monitors PDCCHs only in a CORESET, and in any other CORESET from the multiple CORESETs having same QCL-TypeD properties as the CORESET, on the active DL BWP of a cell from the one or more cells—the CORESET that corresponds to the CSS set with the lowest index in the cell with the lowest index containing CSS, if any; otherwise, to the USS set with the lowest index in the cell with lowest index.

The UE shall be expected to be able to receive with a different QCL-TypeD property than that of the CORESET, a non-CORESET symbol that is not adjacent to the CORESET but is adjacent to at-least one of the PDCCH monitoring occasions that have different QCL-TypeD properties from the CORESET.

In another embodiment, the UE gives precedence of CORESET having lower ID and once that is ensured it avoids switching on CORESET-2 symbols and receives the remaining symbols (including CORESET-2 symbols) using beam of CORESET-1. Indeed, switching to the beam corresponding to the PDSCH symbols is done only on a gap symbol whenever such a symbol is present prior to any PDSCH symbol scheduled for that UE.

In an alternate embodiment, the UE gives precedence of CORESET having lower ID and once that is ensured it avoids switching on CORESET-2 symbols and receives the remaining symbols of CORESET-2 using beam of CORESET-1. Switching to the beam corresponding to the scheduled PDSCH symbols is done, when necessary, only on either a gap symbol if such a symbol is known to the UE to be present before the first scheduled PDSCH symbol, or on the latter symbol whenever presence of such a gap symbol is not known to the UE.

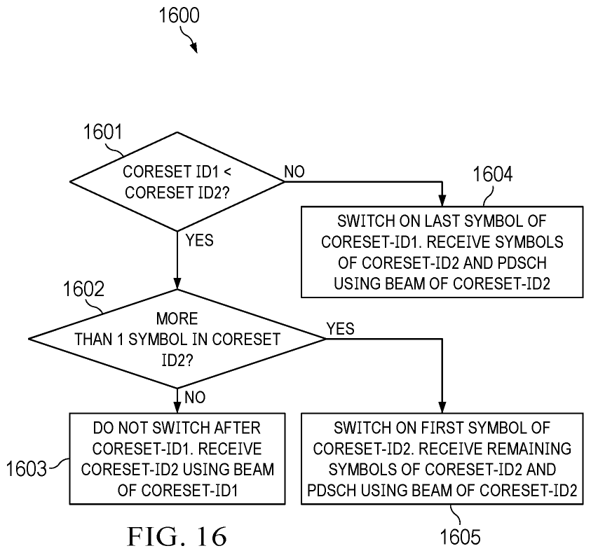

In another embodiment, the UE processing is depicted in the flow chart 1600 in FIG. 16. The idea is to give precedence of the CORESET having a lower ID. Once that is ensured, precedence is given to CORESET-2 symbols. However, if upon satisfying precedence of CORESET-1, the sole symbol of CORESET-2 will be lost whenever a switching is done on that symbol. This disclosure proposes to avoid the switch after CORESET-1 symbols and receive the remaining symbols using beam of CORESET-1. In step 1601, if CORESET ID-1 is not less than CORESET ID-2, then the UE switches on the last symbol of CORESET ID-1 and receives symbols of CORESET ID-2 and PDSCH using the beam of CORESET ID-2, as shown in 1604. In step 1601, if CORESET ID-1 is less than CORESET ID-2, then the UE determines if there is more than one symbol in CORESET ID-2, in step 1602. If there is more than one symbol in CORESET ID-2, then the UE switches on the first symbol of CORESET ID-2 and receives the remaining symbols of CORESET ID-2 and PDSCH using the beam of CORESET ID-2, as shown in 1605. If there is not more than one symbol in CORESET ID-2, then the UE does not switch after CORESET ID-1 and receives the symbols of CORESET ID-2 using the beam of CORESET ID-1, as shown in 1603.

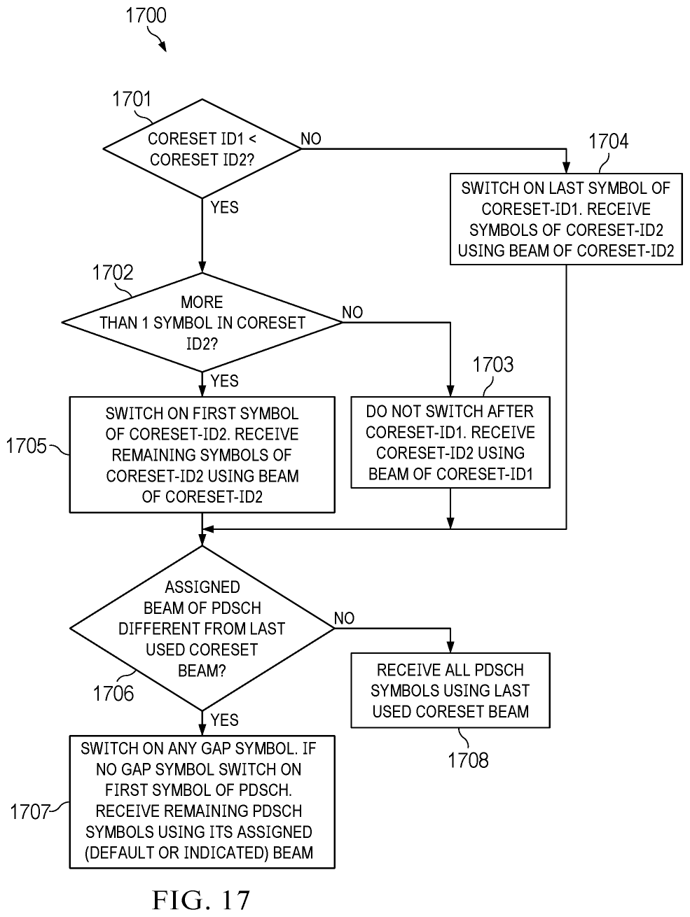

In another embodiment depicted in the flow chart 1700 in FIG. 17, this disclosure proposes to switch on the first PDSCH symbol to receive remaining symbols using its assigned (either pre-configured default or DCI indicated) beam whenever the latter beam is different from last used CORESET beam. In step 1701, if CORESET ID-1 is not less than CORESET ID-2, then the UE switches on the last symbol of CORESET ID-1 and receives symbols of CORESET ID-2 using the beam of CORESET ID-2, as shown in 1704. In step 1701, if CORESET ID-1 is less than CORESET ID-2, then the UE determines if there is more than one symbol in CORESET ID-2, in step 1702. If there is more than one symbol in CORESET ID-2, then the UE switches on the first symbol of CORESET ID-2 and receives the remaining symbols of CORESET ID-2 using the beam of CORESET ID-2, as shown in 1705. If there is not more than one symbol in CORESET ID-2, then the UE does not switch after CORESET ID-1 and receives the symbols of CORESET ID-2 using the beam of CORESET ID-1, as shown in 1703. In step 1706, the UE determines if the assigned beam of the PDSCH is different from the last used CORESET beam. If the assigned beam of the PDSCH is different from the last used CORESET beam, the UE switches on any gap symbol, or if there is no gap symbol, then the UE switches on the first symbol of the PDSCH and receives the remaining PDSCH symbols using the UE's assigned (e.g., default or indicated) beam, as shown in step 1707. In step 1706, if the assigned beam of the PDSCH is the same as the last used CORESET beam, the UE receives all PDSCH symbols using the last used CORESET beam, as shown in step 1708.

Example priority tables are depicted in Table 1 and Table 2. Recall that indeterminate symbols are symbols that may or may not correspond to some assigned PDSCH or CSI-RS symbols. The exact status of these symbols will be known to the UE once it decodes the DCI intended for it that is present in the monitoring occasion(s) that could contain such a DCI capable of assigning those symbols. Moreover, when no such DCI is detected by the UE, it rules out the presence of such DCI in those monitoring occasions and all these indeterminate symbols are deemed to be gap symbols.

In a further embodiment, the switching is done only on the gap symbols. In addition, the UE must either receive each symbol with its corresponding receive beam (assigned or inferred) or if such reception is not possible under its beam switch capability, a beam associated with a symbol of at-least as high a priority. Put differently, the beam that is employed to receive any pair of adjacent symbols with distinct corresponding beams will be one that corresponds to a symbol with at-least as high a priority as both those symbols.

TABLE 1
Priority levels (in decreasing order) of Signal Types

| Priority Level | Signal(s) |
|---|---|
| 0 | SSB, CSI-RS for L1-RSRP |
| 1 | CORESET containing CSS. Among |
| | multiple such CORESETs, CORESET with |
| | CSS of lower index (ID) has higher priority |
| | than one with CSS of higher index. |
| 2 | CORESET containing USS. Among |
| | multiple such CORESETs, CORESET with |
| | USS of lower index has higher priority than |
| | one with USS of higher index. |
| 3 | CSI-RS for tracking/beam training/CQI |
| 4 | PDSCH DMRS |
| 5 | PDSCH data symbol |
| 6 | Indeterminate symbol |
| 7 | Gap symbol |

TABLE 2
Priority levels (in decreasing order) of Signal Types

| Priority Level | Signal(s) |
|---|---|
| 0 | SSB, CSI-RS for L1-RSRP |
| 1 | CORESET ID = 0 |
| 2 | CORESETs with ID > 0. Among multiple |
| | such CORESETs, CORESET with lower |
| | index has higher priority than one with |
| | higher index. |
| 3 | CSI-RS for tracking/beam training/CQI |
| 4 | PDSCH DMRS |
| 5 | PDSCH data symbol |
| 6 | Indeterminate symbol |
| 7 | Gap symbol |

Additionally, multiple sets of embodiments targeting specific scenarios are disclosed in the paragraphs below.

In the first set of embodiments, a scenario depicted in FIG. 13 is considered. Here the UE must monitor symbol(s) of a common search space set (associated with CORESET with ID=0) and must also monitor symbol(s) of a user-specific search space set (associated with CORESET with ID=1) and these CORESETs have different corresponding beams (depicted in the first and last symbols, respectively). The one or more symbols in between can correspond to PDSCH or CSI-RS symbols whose corresponding beams and locations can be known to the UE (after having decoded some prior DCI) or they can be indeterminate symbols.

Suppose that the UE receives the symbol(s) of the CSS using the associated beam. Further the default beam to receive the indeterminate symbols are determined as per rules discussed before.

Then, in the first embodiment, the default beam is the same as that of CSS (CORESET ID=0). In this embodiment, the UE switches the beam from the default to the USS beam (CORESET ID=1) in the indeterminate symbol immediately preceding the first USS symbol.

In the second embodiment, the default beam is distinct from that of CSS (CORESET ID=0). In this embodiment the UE switches the beam from CSS beam to the default in the indeterminate symbol immediately succeeding last CSS symbol and to the USS beam (CORESET ID=1) in the indeterminate symbol immediately preceding the first USS symbol.

In the third embodiment, the UE first checks if there is a symbol that can be ascertained to be a gap symbol even before decoding any DCI intended for it in the CSS or any prior hitherto undecoded DCI(s). This can be done for instance, based on the set of DCI formats that can be present in the CSS or those prior undecoded DCI(s) and their associated start and length indicator (SLIV) tables. If it finds any such symbols then it switches its beam from the default to the USS beam during any one symbols that it can.

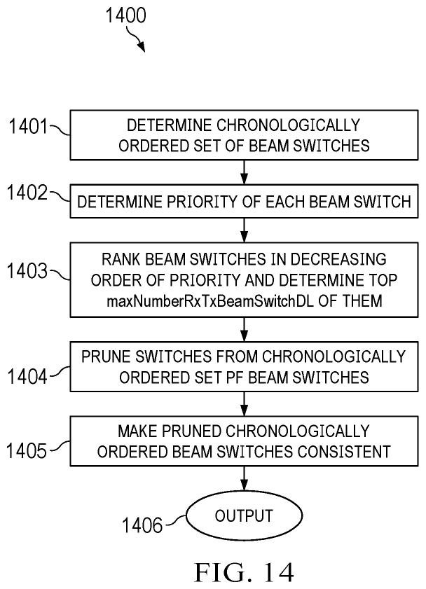

Also disclosed are embodiments designed in order to further incorporate per-slot number of beam switches limit given by maxNumberRxTxBeamSwitchDL. Flowchart 1400 in FIG. 14 shows details of example embodiments.

In one such embodiment, over any slot, beginning with the current beam at the onset of a slot, a chronologically ordered list of all beam switches is prepared, as shown in step 1401. The list comprises the order in time in which beam switches would occur in the slot if there was no limit on the number of switches in that slot. Here, the symbols on which each switch would occur can be decided based on any of the previous embodiments on beam switching. Then, in step 1402, a priority of a switch is set to be the priority of the symbol whose corresponding beam is the result or output of the switching (cf. for priority, Table 1 and Table 2). Switches are ranked in the decreasing order of their priorities in step 1403. In the original ordered set of beam switches all switches with lower priority than the first highest maxNumberRxTxBeamSwitchDL priorities are dropped, as shown in step 1404. The pruned ordered set is made consistent by replacing the input of each retained switch with the output of the preceding retained switch (or with beam at the onset of slot if the first switch in the ordered set is dropped), as shown in step 1405. The chronologically ordered set of beam switches is output in step 1406.

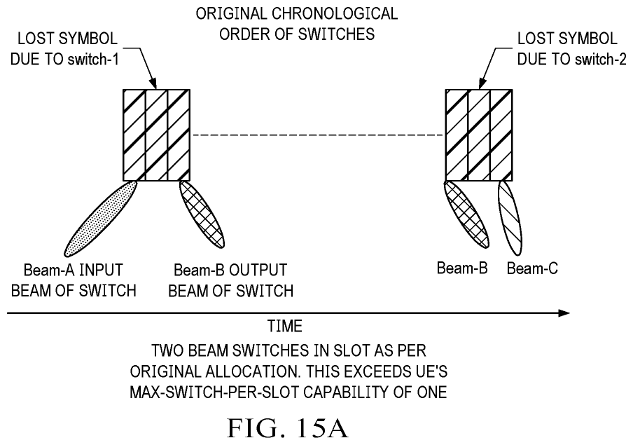

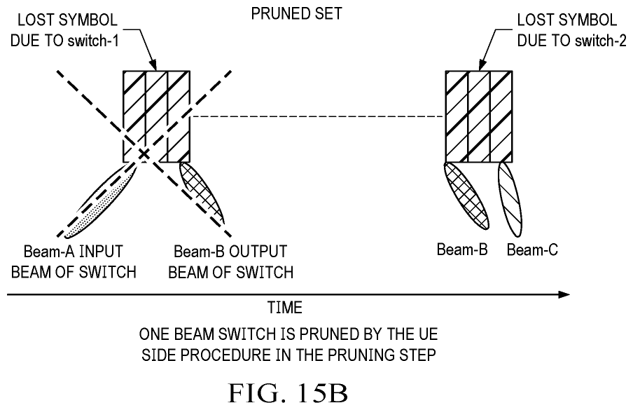

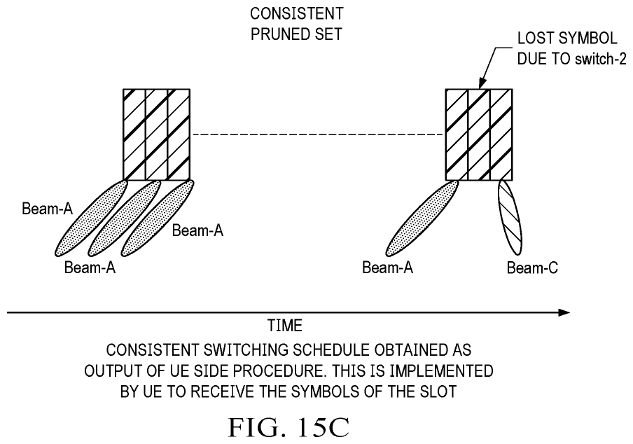

Example embodiments are shown in FIG. 15A-FIG. 15C. The UE performs switching as per the ordered output list and buffers symbols received in the interim between those switches (with symbol on which a switch occurs being lost if necessary, in order to accommodate switching gap).

In one embodiment, all buffered PDSCH symbols in the slot are processed. In addition, buffered monitoring occasion symbols and RS symbols that have been buffered using their original corresponding beams are also processed.

In another embodiment, all buffered PDSCH symbols in the slot are processed. In addition, buffered symbols from each monitoring occasion such that all of its symbols have been buffered using the original corresponding beam, are also processed. In one extension of this embodiment, symbols of monitoring occasions which will not be received using their respective original corresponding beams or some symbols of which will be lost need not be buffered by the UE.

In yet another embodiment, all buffered PDSCH symbols in the slot are processed. In addition, buffered RS symbols that have been buffered using their original corresponding beams are also processed. Furthermore, buffered symbols from each monitoring occasion such that all of its symbols have been buffered using the original corresponding beam, are also processed.

In one embodiment, a UE is expected to be able to receive each symbol in a slot using its corresponding beam whenever the priority of this symbol is one of top maxNumberRxTxBeamSwitchDL highest priorities among all symbols in the slot and this symbol is not adjacent to a symbol in the slot with a higher priority and a distinct corresponding beam.

In one embodiment, a UE is expected to prioritize reception based on a priority ranking and is expected to receive symbols in a slot whose priorities are in the top maxNumberRxTxBeamSwitchDL highest priorities among symbols in that slot.

In another embodiment, a UE is expected to prioritize reception based on a priority ranking and is expected to receive symbols in a slot whose associated signal, and/or channel, priorities in the top maxNumberRxTxBeamSwitchDL highest priorities among those of symbols in that slot.

In another embodiment, a UE is expected to be able to receive each symbol in a slot using its corresponding beam whenever the priority of this symbol is one of top maxNumberRxTxBeamSwitchDL highest priorities among all symbols in the slot and this symbol is not adjacent to a symbol in the slot with a higher priority and a distinct corresponding beam. In addition, the UE is expected to also receive, using the beam from the most recent switch, each PDSCH symbol whose priority does not lie in the top maxNumberRxTxBeamSwitchDL highest priorities and which is immediately preceded and succeeded by either gap symbols or other PDSCH symbols.

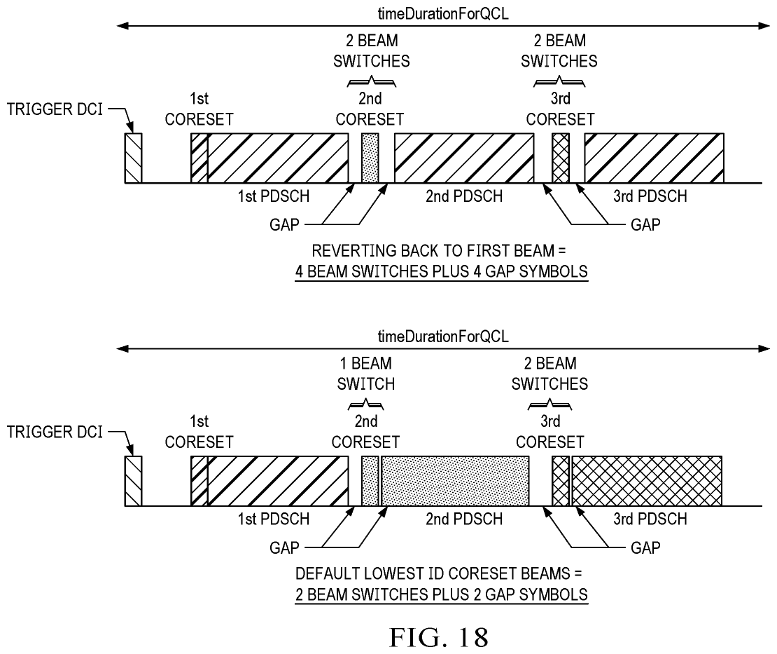

There is a connection between the choice of default beam and the beam switch gap. Specifically, recall that in case 2, the gNB does not have the option of making the UE follow an indicated beam. Here the default choice of mandating UE to follow QCL assumption derived from the most-recently monitored lowest ID CORESET has the advantage of reducing the number of UE beam switches and possibly gap symbols. To illustrate this point, FIG. 18 shows that making UE follow the QCL assumption derived from a pre-configured default over all its remaining PDSCH slots can potentially impose up-to twice the number of beam switches on the UE, and possibly can require provisioning of a larger number of gap symbols. The increased number of gap symbols is arising from the need to monitor PDCCH symbols that can be associated with a different beam.

Recall that the general case outlined in FIG. 2 in which some scheduled PDSCH have offsets less than timeDurationForQCL while some have offsets at-least as large as timeDurationForQCL.

In this case, UE can employ any one of the default beam selection rules described above for buffering PDSCH with time offsets less than or equal to timeDurationForQCL, while it has the option of using the indicated beam (TCI state) for the other PDSCH. However, when the two beams (last used default beam and indicated beam) are different, switching between them can entail a gap which must be accommodated. Moreover, the limit on the max number of switches in a slot must also be considered.

In one embodiment, the UE uses the default beam(s) for all PDSCH with scheduling offsets less than timeDurationForQCL and the indicated TCI state (beam based on indicated TCI state) for all other scheduled PDSCH.

The beam switch, in case the last used default beam is distinct from the one based on indicated TCI state, is done on the first gap symbol immediately preceding a PDSCH symbol with time offset no less than timeDurationForQCL. No switch from last used default beam is done if no TCI state is indicated.

In another embodiment, the switch in case the last used default beam is distinct from the one based on indicated TCI state is done on the first gap symbol immediately preceding the first PDSCH with scheduling offset no less than timeDurationForQCL. If no such gap symbol is present, then a beam switch is not done.

In yet another embodiment, the switch in case the last used default beam is distinct from the one based on indicated TCI state is done on the first gap symbol immediately preceding the first PDSCH with scheduling offset no less than timeDurationForQCL. If no such gap symbol is present, then a beam switch is done on the first symbol of that first PDSCH.

In yet another embodiment, the switch in case the last used default beam is distinct from the one based on indicated TCI state is done on the first gap symbol immediately preceding the first PDSCH symbol with time offset no less than timeDurationForQCL. If no such gap symbol is present, then a beam switch is done on that first PDSCH symbol.

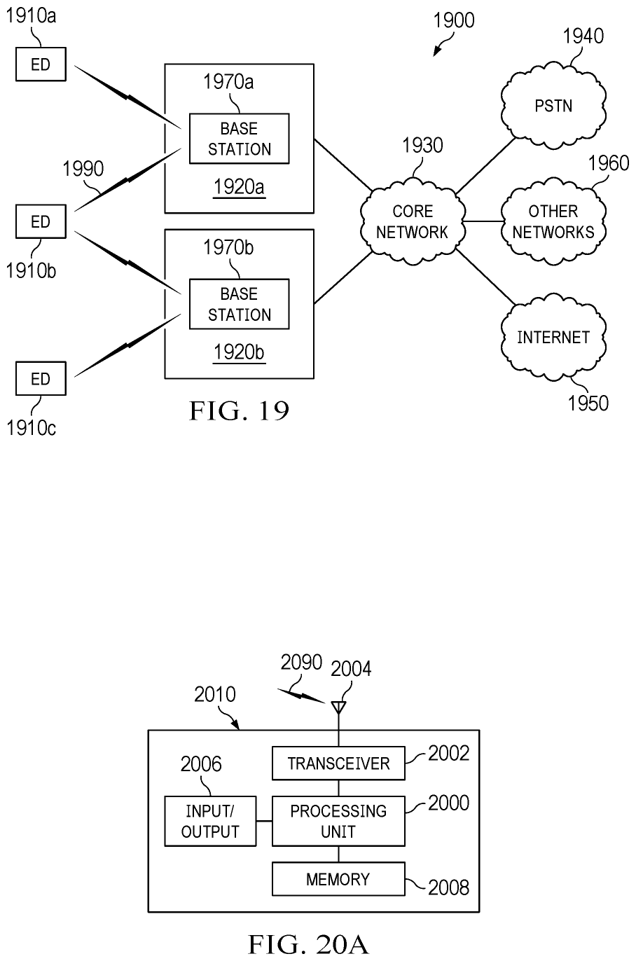

FIG. 19 illustrates an example communication system 1900. In general, the system 1900 enables multiple wireless or wired users to transmit and receive data and other content. The system 1900 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1900 includes electronic devices (ED) 1910a-1910c, radio access networks (RANs) 1920a-1920b, a core network 1930, a public switched telephone network (PSTN) 1940, the Internet 1950, and other networks 1960. While certain numbers of these components or elements are shown in FIG. 19, any number of these components or elements may be included in the system 1900.

The EDs 1910a-1910c are configured to operate or communicate in the system 1900. For example, the EDs 1910a-1910c are configured to transmit or receive via wireless or wired communication channels. Each ED 1910a-1910c represents any suitable end user device and may include such devices (or may be referred to) as a user equipment (UE) or device, wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1920a-1920b here include base stations 1970a-1970b, respectively. Each base station 1970a-1970b is configured to wirelessly interface with one or more of the EDs 1910a-1910c to enable access to the core network 1930, the PSTN 1940, the Internet 1950, or the other networks 1960. For example, the base stations 1970a-1970b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 1910a-1910c are configured to interface and communicate with the Internet 1950 and may access the core network 1930, the PSTN 1940, or the other networks 1960.

In the embodiment shown in FIG. 19, the base station 1970a forms part of the RAN 1920a, which may include other base stations, elements, or devices. Also, the base station 1970b forms part of the RAN 1920b, which may include other base stations, elements, or devices. Each base station 1970a-1970b operates to transmit or receive wireless signals within a particular geographic region or area, sometimes referred to as a “cell.” In some embodiments, multiple-input multiple-output (MIMO) technology may be employed having multiple transceivers for each cell.

The base stations 1970a-1970b communicate with one or more of the EDs 1910a-1910c over one or more air interfaces 1990 using wireless communication links. The air interfaces 1990 may utilize any suitable radio access technology.

It is contemplated that the system 1900 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1920a-1920b are in communication with the core network 1930 to provide the EDs 1910a-1910c with voice, data, application, Voice over Internet Protocol (VoIP), or other services. Understandably, the RANs 1920a-1920b or the core network 1930 may be in direct or indirect communication with one or more other RANs (not shown). The core network 1930 may also serve as a gateway access for other networks (such as the PSTN 1940, the Internet 1950, and the other networks 1960). In addition, some or all of the EDs 1910a-1910c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1950.

Although FIG. 19 illustrates one example of a communication system, various changes may be made to FIG. 19. For example, the communication system 1900 could include any number of EDs, base stations, networks, or other components in any suitable configuration.

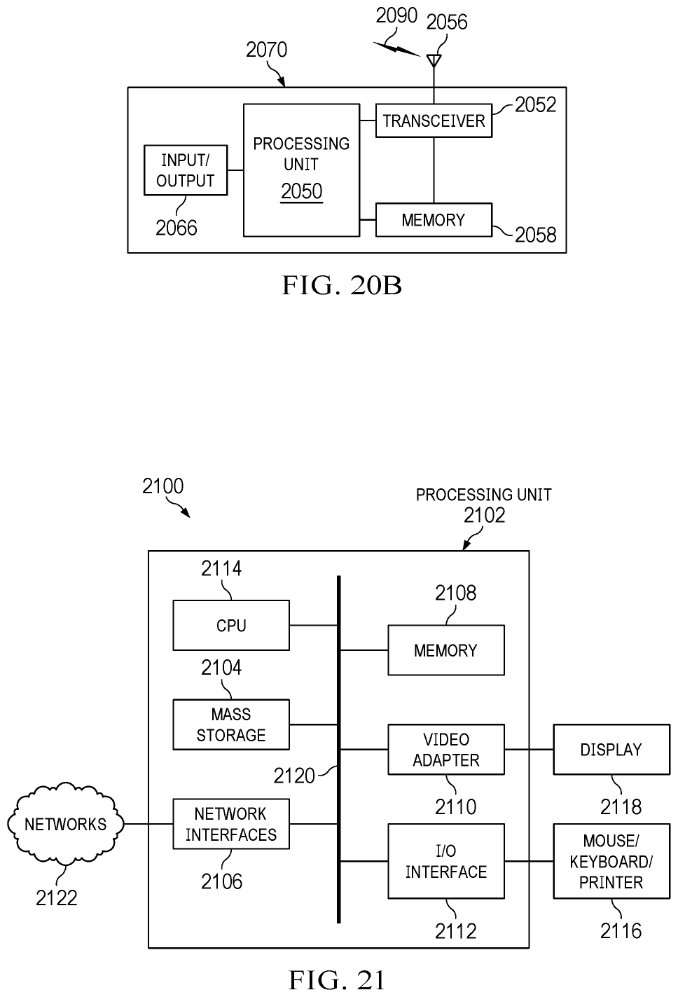

FIGS. 20A and 20B illustrate example devices that may implement the methods and teachings according to this disclosure. In particular, FIG. 20A illustrates an example ED 2010, and FIG. 20B illustrates an example base station 2070. These components could be used in the system 1900 or in any other suitable system.

As shown in FIG. 20A, the ED 2010 includes at least one processing unit 2000. The processing unit 2000 implements various processing operations of the ED 2010. For example, the processing unit 2000 could perform signal coding, data processing, power control, input/output processing, or any other functionality enabling the ED 2010 to operate in the system 1900. The processing unit 2000 also supports the methods and teachings described in more detail above. Each processing unit 2000 includes any suitable processing or computing device configured to perform one or more operations. Each processing unit 2000 could, for example, include a microprocessor, microcontroller, digital signal processor, field programmable gate array, or application specific integrated circuit.

The ED 2010 also includes at least one transceiver 2002. The transceiver 2002 is configured to modulate data or other content for transmission by at least one antenna or NIC (Network Interface Controller) 2004. The transceiver 2002 is also configured to demodulate data or other content received by the at least one antenna 2004. Each transceiver 2002 includes any suitable structure for generating signals for wireless or wired transmission or processing signals received wirelessly or by wire. Each antenna 2004 includes any suitable structure for transmitting or receiving wireless or wired signals. One or multiple transceivers 2002 could be used in the ED 2010, and one or multiple antennas 2004 could be used in the ED 2010. Although shown as a single functional unit, a transceiver 2002 could also be implemented using at least one transmitter and at least one separate receiver.

The ED 2010 further includes one or more input/output devices 2006 or interfaces (e.g., a wired interface to the Internet 1950). The input/output devices 2006 facilitate interaction with a user or other devices (e.g., network communications) in the network. Each input/output device 2006 includes any suitable structure for providing information to or receiving information from a user, such as a speaker, microphone, keypad, keyboard, display, or touch screen, including network interface communications.

In addition, the ED 2010 includes at least one memory 2008. The memory 2008 stores instructions and data used, generated, or collected by the ED 2010. For example, the memory 2008 could store software or firmware instructions executed by the processing unit(s) 2000 and data used to reduce or eliminate interference in incoming signals. Each memory 2008 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 20B, the base station 2070 includes at least one processing unit 2050, at least one transceiver 2052, which includes functionality for a transmitter and a receiver, one or more antennas 2056, at least one memory 2058, and one or more input/output devices or interfaces 2066. A scheduler, which would be understood by one skilled in the art, is coupled to the processing unit 2050. The scheduler could be included within or operated separately from the base station 2070. The processing unit 2050 implements various processing operations of the base station 2070, such as signal coding, data processing, power control, input/output processing, or any other functionality. The processing unit 2050 can also support the methods and teachings described in more detail above. Each processing unit 2050 includes any suitable processing or computing device configured to perform one or more operations. Each processing unit 2050 could, for example, include a microprocessor, microcontroller, digital signal processor, field programmable gate array, or application specific integrated circuit.

Each transceiver 2052 includes any suitable structure for generating signals for wireless or wired transmission to one or more EDs or other devices. Each transceiver 2052 further includes any suitable structure for processing signals received wirelessly or by wire from one or more EDs or other devices. Although shown combined as a transceiver 2052, a transmitter and a receiver could be separate components. Each antenna 2056 includes any suitable structure for transmitting or receiving wireless or wired signals. While a common antenna 2056 is shown here as being coupled to the transceiver 2052, one or more antennas 2056 could be coupled to the transceiver(s) 2052, allowing separate antennas 2056 to be coupled to the transmitter and the receiver if equipped as separate components. Each memory 2058 includes any suitable volatile or non-volatile storage and retrieval device(s). Each input/output device 2066 facilitates interaction with a user or other devices (network communications) in the network. Each input/output device 2066 includes any suitable structure for providing information to or receiving/providing information from a user, including network interface communications.

FIG. 21 is a block diagram of a computing system 2100 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 2100 includes a processing unit 2102. The processing unit includes a central processing unit (CPU) 2114, memory 2108, and may further include a mass storage device 2104, a video adapter 2110, and an I/O interface 2112 connected to a bus 2120.

The bus 2120 may be one or more of any type of several bus architectures including a memory bus or memory controller, a peripheral bus, or a video bus. The CPU 2114 may comprise any type of electronic data processor. The memory 2108 may comprise any type of non-transitory system memory such as static random access memory (SRAM), dynamic random access memory (DRAM), synchronous DRAM (SDRAM), read-only memory (ROM), or a combination thereof. In an embodiment, the memory 2108 may include ROM for use at boot-up, and DRAM for program and data storage for use while executing programs.

The mass storage 2104 may comprise any type of non-transitory storage device configured to store data, programs, and other information and to make the data, programs, and other information accessible via the bus 2120. The mass storage 2104 may comprise, for example, one or more of a solid state drive, hard disk drive, a magnetic disk drive, or an optical disk drive.

The video adapter 2110 and the I/O interface 2112 provide interfaces to couple external input and output devices to the processing unit 2102. As illustrated, examples of input and output devices include a display 2118 coupled to the video adapter 2110 and a mouse, keyboard, or printer 2116 coupled to the I/O interface 2112. Other devices may be coupled to the processing unit 2102, and additional or fewer interface cards may be utilized. For example, a serial interface such as Universal Serial Bus (USB) (not shown) may be used to provide an interface for an external device.

The processing unit 2102 also includes one or more network interfaces 2106, which may comprise wired links, such as an Ethernet cable, or wireless links to access nodes or different networks. The network interfaces 2106 allow the processing unit 2102 to communicate with remote units via the networks. For example, the network interfaces 2106 may provide wireless communication via one or more transmitters/transmit antennas and one or more receivers/receive antennas. In an embodiment, the processing unit 2102 is coupled to a local-area network 2122 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed:

1. A method comprising:
receiving, by a user equipment (UE), a downlink control information (DCI), the DCI scheduling one or more data channel transmissions;
determining, by the UE, a TCI-state based on a time duration for quasi co-location (QCL) and a scheduling offset; and
receiving, by the UE and based on the TCI-state, data symbols from the one or more data channel transmissions scheduled by the DCI.

2. The method of claim 1, wherein the scheduling offset comprises a time offset between a physical downlink control channel (PDCCH) monitoring occasion that comprises the DCI and the corresponding PDSCH.

3. The method of claim 1, wherein the scheduling offset is less than the time duration for QCL, and wherein the TCI-state indicates a beam utilized in receiving.

4. The method of claim 3, wherein a first data symbol of the data symbols is at least the time duration for QCL after a PDCCH monitoring occasion comprising the DCI.

5. The method of claim 3, wherein a default beam corresponds to a search space set of a plurality of search space sets, and wherein each default beam of each search space set of the plurality of search space sets is indicated by a corresponding TCI-state containing QCL information and a reference signal associated with the default beam.

6. The method of claim 3, wherein one or more control resource sets (CORESETs) are assigned to the UE, wherein each of the one or more CORESETs is configured with a corresponding flag, wherein the one or more CORESETs comprises at least one CORESET with the corresponding flag set to be true, and wherein the default beam is based on QCL parameters of a CORESET with a lowest CORESET identifier (ID) among the at least one CORESET.

7. The method of claim 6, wherein each corresponding flag is UE-specific and configured via radio resource control (RRC) signaling.

8. The method of claim 6, wherein the at least one CORESET with the corresponding flag set to be true is prior to a slot containing the data symbols.

9. The method of claim 1, wherein the scheduling offset is greater than or equal to the time duration for QCL, and
wherein the TCI-state is conveyed via a transmit configuration indicator (TCI) field indicated by the DCI, or
wherein the TCI-state indicates a prior TCI state used by a monitoring occasion containing the DCI, and wherein the TCI field is absent in the DCI.

10. The method of claim 1, wherein a time gap between any consecutive PDCCH monitoring occasions with UE-specific search space sets (USSs) is greater than or equal to the time duration for QCL.

11. The method of claim 1, wherein the time duration for QCL is configured by a base station using RRC signaling.

12. The method of claim 1, further comprising:
receiving, by the UE, a second DCI, wherein at least one of the DCI or the second DCI schedules multi-slot transmission, and wherein the second DCI is ignored by the UE.

13. The method of claim 1, wherein the TCI-state indicates a first receive beam that is different from a second receive beam with a reference signal having a QLC type indicated by a current TCI-state, the method further comprising:
determining, by the UE, a decision of a TCI state switch associated with the current TCI-state to the TCI-state based on a precedence relation.

14. A user equipment (UE) comprising:
one or more processors; and
at least one non-transitory memory storage comprising instructions that, when executed by the one or more processors, cause the UE to:
receive a downlink control information (DCI), the DCI scheduling one or more data channel transmissions;
determine a TCI-state based on a time duration for quasi co-location (QCL) and a scheduling offset; and
receive, based on the TCI-state, data symbols from the one or more data channel transmissions scheduled by the DCI.

15. The UE of claim 14, wherein the scheduling offset comprises a time offset between a physical downlink control channel (PDCCH) monitoring occasion that comprises the DCI and the corresponding PDSCH.

16. The UE of claim 14, wherein the scheduling offset is less than the time duration for QCL, and wherein the TCI-state indicates a beam utilized in receiving.

17. The UE of claim 14, wherein the scheduling offset is greater than or equal to the time duration for QCL, and
wherein the TCI-state is conveyed via a transmit configuration indicator (TCI) field indicated by the DCI, or
wherein the TCI-state indicates a prior TCI state used by a monitoring occasion containing the DCI, and wherein the TCI field is absent in the DCI.

18. The UE of claim 14, wherein the time duration for QCL is configured by a base station using RRC signaling.

19. The UE of claim 14, wherein the UE is further caused to:
receive a second DCI, wherein at least one of the DCI or the second DCI schedules multi-slot transmission, and wherein the second DCI is ignored by the UE.

20. The UE of claim 14, wherein the TCI-state indicates a first receive beam that is different from a second receive beam with a reference signal having a QLC type indicated by a current TCI-state, the UE further caused to:
determine a decision of a TCI state switch associated with the current TCI-state to the TCI-state based on a precedence relation.
